(19) United States
(12) Patent Application Publication
(10) Pub. No.: US 2006/0235804 A1
(43) Pub. Date: Oct. 19, 2006

(54) Service providing system, service using device, service proving device, service relaying device, method for performing authentication, authentication program, and recording medium thereof

(75) Inventor: Masafumi Hirata, Ichikawa-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-Shi (JP)

(21) Appl. No.: 11/227,119

(22) Filed: Sep. 16, 2005

Related U.S. Application Data
(60) Provisional application No. 60/672,066, filed on Apr. 18, 2005.
(60) Provisional application No. 60/712,392, filed on Aug. 31, 2005.

(51) Int. Cl. H04L 9/00

(52) U.S. Cl. 705/67

(57) ABSTRACT

In first-time authentication, non-enciphered authentication information (user ID, password), which is provided from a user, is transmitted from a portable telephone (service using device) 10 to a server (service providing device) 20. The server 20 performs authentication for the non-enciphered authentication information thus received from the portable telephone 10. If the authentication is successful, the server 20 enciphers the authentication information, and sends the enciphered authentication information back to the portable telephone 10. The portable telephone 10 stores therein the enciphered authentication information thus received from the server 20. To request the same server 20 to provide a service next time or later, the thus stored enciphered authentication information is transmitted from the portable telephone 10 to the server 20. The server 20 receives and deciphers the enciphered authentication information. Then, the server 20 performs authentication for the thus deciphered authentication information. With this arrangement, input operation of the authentication information by the use is reduced and security of the authentication information is improved in a service providing system including a service using device and a service providing device that provides a service to the service using device.

This nonprovisional application claims the benefit of U.S. Provisional Applications Ser. No. 60/672,066 filed on Apr. 18, 2005, and ATTY. Docket No. 1248-0807PUS1 filed on Aug. 31, 2005, the entire contents of all of which are hereby incorporated by reference.

### FIELD OF THE INVENTION

The present invention relates to an authentication method for performing authentication for a user of a service using device in a service providing system comprising the service using device, and a service providing device for providing a service to the service using device. The present invention also relates to a providing system, an information terminal device, a service providing device, and a service relaying device, each of which is for realizing the authentication method. The present invention also relates to an authentication program for causing a computer to execute the authentication method, and a recording medium thereof.

### BACKGROUND OF THE INVENTION

There have been conventional arts for providing various services from a service providing device on a network (such as the Internet or the like) to an information terminal device (service using device; such as a personal computer, a portable phone, or the like)) connected to the service providing devices via the network.

Some of the services are, for example, such services that are provided to only a user who has been registered in advance. In the case of such services, the service providing device generally performs authentication process of the user referring to authentication information (such as user ID (use name), password, or the like), which, prior to the providing of the service, is sent to the service providing device from the information terminal device connected to the service providing device. Only if the authentication is successful, the service is provided from the service providing device to the user.

FIG. 12 is an explanatory view illustrating an example of a conventional service providing system in which user authentication is carried out. A service providing system 100 illustrating in FIG. 12 is provided with a portable phone 101 and a service providing device 102. The portable phone 101 and the service providing device 102 are connected via the Internet. The service providing device 102 stores therein a combination of a user ID and a password which have been preset for the user authorized to receive the service.

In order to be provided with the service that the service providing device 102 provides, the user of the portable phone 101 inputs the user ID and password into the portable phone 101. Then, the user ID and password are transmitted to the service providing device 102. The service providing device 102, which has received the user ID and password from the portable phone 101, matches the thus received combination of the user ID and password against the combination of the user ID and password stored in the service providing device 102 in advance. If these combinations match with each other, the user is authenticated successfully as the user authorized to receive the service. Then, contents of the service to be provided is transmitted to the portable telephone 101.

Moreover, Japanese Patent publication, Tokukai, No. 200-1-320366 (published on Nov. 16, 2001) discloses an art in which a means for authenticating a password is provided in a server. In this art, the password is inputted into a text field of portable information terminal for transmitting/receiving information to/from the server via the Internet. This art prevents input of mistyped password into the portable information terminal.

Moreover, on an article titled “Save time with Autocomplete” published by Microsoft on the Internet <URL: http://www.microsoft.com/windows/ie_intl/ja/using/how to/customizing/autocomplete.mspx> on Mar. 16, 2003 (searched on Apr. 13, 2005), a technology called “autocomplete” is described. By a web browser used by a personal computer with autocomplete, information once inputted by a user is stored, and what is being typed by a user in inputting new information is anticipated based on the stored information and a possible match thus anticipated is displayed. Moreover, it is suggested to perform the “autocomplete” for a user name and password.

In the conventional arts, however, it is necessary to input a user ID and password every time the service is to be provided. This is very inconvenient. Especially, the information terminal devices such as portable phones and the like are so arranged that characters are selected by pushing an individual key plural times. In the information terminal devices, it is very inconvenient to input the user ID and/or password every time.

Even though the autocompletion alleviates the input operation in the technology of “Save time with Autocomplete”, it is still necessary to carry out the input operation every time. Therefore, the technology of “Save time with Autocomplete” is not a solution for the essential problem, that is, the user's inconvenience.

Furthermore, each of the conventional arts has security problems in that there is a risk that the user ID and/or password is sneakily read from surroundings when inputting the user ID and the password, or that the user ID and/or password is tapped in a transmission route between the information terminal and the server. Moreover, in the technology of “Save time with Autocomplete”, information (such as the user ID, password, or the like) as inputted is stored in a browser. Therefore, the art of autocompletion has a high risk that the user ID and/or password is leaked to a third party.

### SUMMARY OF THE INVENTION

In view of the aforementioned problem, an object of the present invention is to reduce user's input operation of authentication information and to improve security regarding the authentication information in a service providing system including a service using device and a service providing device that provides a service to the service using device.

A first service providing system of the present invention includes a service using device, and service providing devices each of which provides a given service in accordance with a request from the service using device to which the service providing device is connected via a network. In order to attain the object, the first service providing system is arranged as follows: the service using device includes (a) an input section for receiving an instruction from a user, the instruction specifying a requested service, (b) a cipher storage section for storing therein enciphered authentication information, and (c) a using device control section that transmits enciphered authentication information that corresponds to the requested service, to that service providing device which provides the requested service; and each of the service providing devices includes (A) an authentication information storage section for storing therein authentication information of a user authenticated for a service, (B) an authentication section for performing authentication process for matching authentication information of the user requesting for the service, against the authentication information of the user authorized to receive the service, a deciphering section for deciphering enciphered authentication information so as to create deciphered authentication information, and (C) a providing device control section wherein if the providing device control section receives the enciphered authentication information from the service using device, the providing device control section causes the deciphering section to decipher the thus received enciphered authentication information so as to create deciphered authentication information, and causes the authentication section to perform the authentication process of the thus created deciphered authentication information.

To request for a service, the using device control section transmits the enciphered authentication information to the service providing device in this arrangement. Then, the service providing device deciphers the thus received enciphered authentication information, and performs authentication process for the deciphered authentication information. With this arrangement, unlike the conventional art, the user does not need to input the authentication information every time, the authentication information regarding the requested service. This arrangement, therefore, improve the authentication process to be more user friendly.

Moreover, in this arrangement, the service using device stores the enciphered authentication information. Because of this, the authentication information regarding the service is protected from being stolen, for example, even if a recording region of the service using device is analyzed. Therefore, it is possible to improve security (safety) of the authentication information.

A second service providing system of the present invention includes a service using device, a service relay device, and service providing devices, the service relay device connecting, via a network, the service using device with that service providing device which provides a service that the service using device requests, and the service providing device or service providing devices being connected to the service relaying device via the network. In order to attain the object, the second service providing system is arranged as follows: the service using device includes (a) an input section for receiving an instruction from a user, the instruction specifying a requested service, (b) a cipher storage section for storing therein received enciphered authentication information, and (c) a using device control section that transmits the enciphered authentication information corresponding to the requested service, to the service relaying device; each of the service providing devices includes (A) an authentication information storage section for storing therein authentication information of a user authenticated for a service, and (B) an authentication section for performing authentication process for matching authentication information of the user requesting for the service, against the authentication information of the user authorized to receive the service; and the service relaying device includes (i) a deciphering section for deciphering enciphered authentication information so as to create deciphered authentication information, and (ii) a relaying control section, wherein if the relaying control section receives the enciphered authentication information from the service using device, the relaying control section causes the deciphering section to decipher the thus received enciphered authentication information so as to create deciphered authentication information, and transmits the thus created deciphered authentication information to that service providing device which provides a service that is requested by the service using device having transmitted enciphered authentication information to the relaying control section.

To request for a service, the using device control section transmits the enciphered authentication information to the service relaying device in this arrangement. Then, the service relaying device deciphers the thus received enciphered authentication information thereby to create deciphered authentication information. The service relaying device transmits the deciphered authentication information to the service providing device. The service providing device performs the authentication process for the deciphered authentication information thus received from the service relaying device. With this arrangement, unlike the conventional art, the user does not need to input the authentication information every time, the authentication information regarding the requested service. This arrangement, therefore, improve the authentication process to be more user friendly.

Moreover, in this arrangement, the service using device stores the enciphered authentication information. Because of this, the authentication information regarding the service is protected from being stolen, for example, even if a recording region of the service using device is analyzed. Therefore, it is possible to improve security (safety) of the authentication information.

For a fuller understanding of the nature and advantages of the invention, reference should be made to the ensuing detailed description taken in conjunction with the accompanying drawings.

### BRIEF DESCRIPTION OF THE DRAWINGS

FIGS. 1(a) and 1(b) are explanatory views schematically illustrating an arrangement of a service providing system according to an exemplary embodiment of the present invention.

FIG. 2 is a block diagram schematically illustrating arrangements of a service using device and a service providing device which constitute the service providing system according to the embodiment of the present invention.

FIG. 3 is a flow chart illustrating a flow of first-time authentication process in the service providing system according to the embodiment of the present invention.

FIG. 4 is a flow chart illustrating a flow of non-first-time authentication process in the service providing system according to the embodiment of the present invention.

FIGS. 5(a) and 5(b) are explanatory views schematically illustrating an arrangement of a service providing system according to another exemplary embodiment of the present invention.

FIG. 6 is a block diagram schematically illustrating an arrangement of a service using device, service relaying device, service providing device, which constitute the service providing system according to the another embodiment of the present invention.

FIG. 7 is a flow chart illustrating a flow of first-time authentication process in the service providing system according to the another embodiment of the present invention.

FIG. 8 is a flow chart illustrating a flow of non-first-time authentication process in the service providing system according to the another embodiment of the present invention.

FIGS. 9(a) and 9(b) are explanatory views schematically illustrating an arrangement of a service providing system according to still another exemplary embodiment of the present invention.

FIG. 10 is a flow chart illustrating a flow of first-time authentication process in the service providing system according to the still another embodiment of the present invention.

FIG. 11 is a flow chart illustrating a flow of non-first-time authentication process in the service providing system according to the still another embodiment of the present invention.

FIG. 12 is an explanatory view illustrating an example of a conventional service providing system.

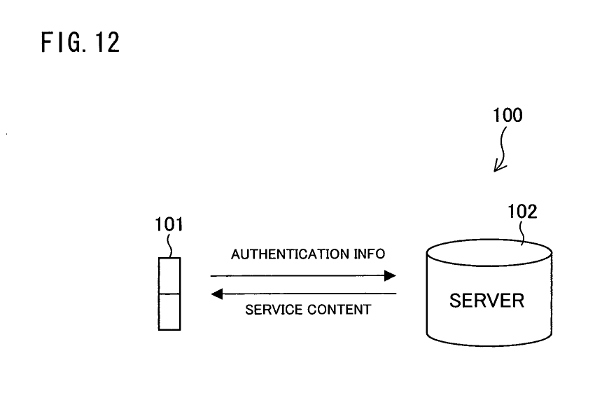

FIG. 13 is an explanatory view schematically illustrating an arrangement of still yet another service providing system according to the present invention.

FIG. 14 is a block diagram schematically illustrating a service using device, a service providing device, a broadcasting base station, which constitute the service providing system illustrated in FIG. 13.

FIG. 15 is a flow chart illustrating a flow of process of the service providing system illustrated in FIG. 13.

FIG. 16 is an explanatory view illustrating a modification of the service providing system illustrated in FIG. 13.

FIG. 17 is an explanatory view illustrating a modification of the service providing system illustrated in FIG. 13.

FIG. 18 is an explanatory view schematically illustrating an arrangement of yet still another service providing system according to the present invention.

FIG. 19 is a block diagram schematically illustrating a service using device, a service relaying device, a service providing device, a broadcasting base station, which constitute the service providing system illustrated in FIG. 18.

FIG. 20 is a flow chart illustrating a flow of process of the service providing system illustrated in FIG. 18.

### DESCRIPTION OF THE EMBODIMENTS

### First Embodiment

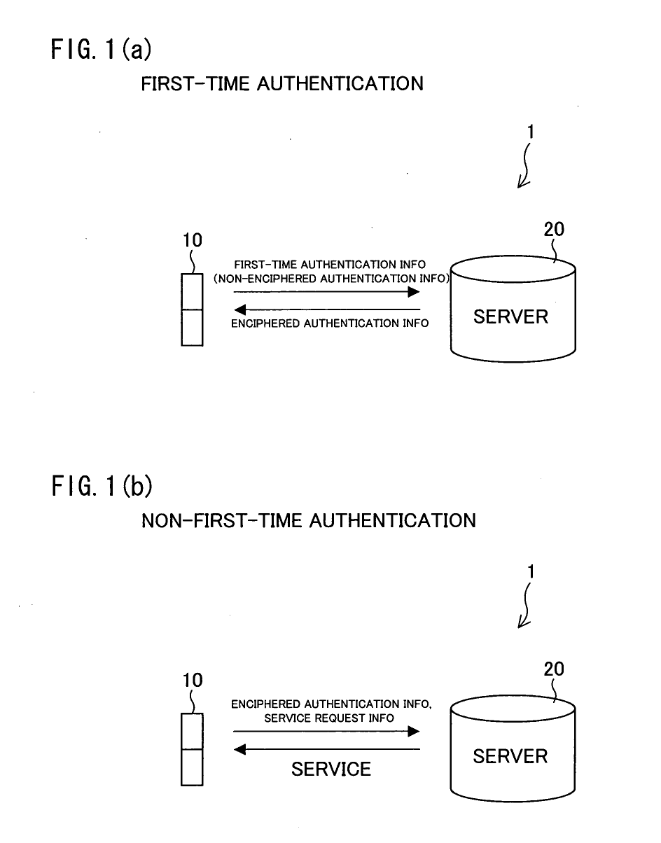

An exemplary embodiment of the present invention is described below, referring to drawings. FIGS. 1(a) and 1(b) are explanatory views schematically illustrating a service providing system 1 according to the present embodiment.

As illustrated in FIGS. 1(a) and 1(b), the service providing system 1 is provided with a portable phone (information terminal device, service using device) 10, and a server (service providing device) 20. The portable telephone 10 and the server 20 are connected with each other via a network such as the Internet or the like, so that they can communicate with each other.

The server 20 is for providing a service to the service using device. Examples of the service the server 20 may provide encompass: blog providing services for providing blog or Weblog (generic name for Web sites which are updated on a daily basis like diaries); book information providing services for providing names of authors, publishers, prices, etc.; on-line storage services for storing image data, photo data, etc. transmitted from the information terminal device; and the other services. It should be noted that these are merely some of examples the service providing system 1 may provide, and the service providing system 1 may provide various and many other services.

Moreover, even though only one server 20 is illustrated in FIGS. 1(a) and 1(b), there are a large number of servers 20 on the network, and each of the server 20 provides certain services.

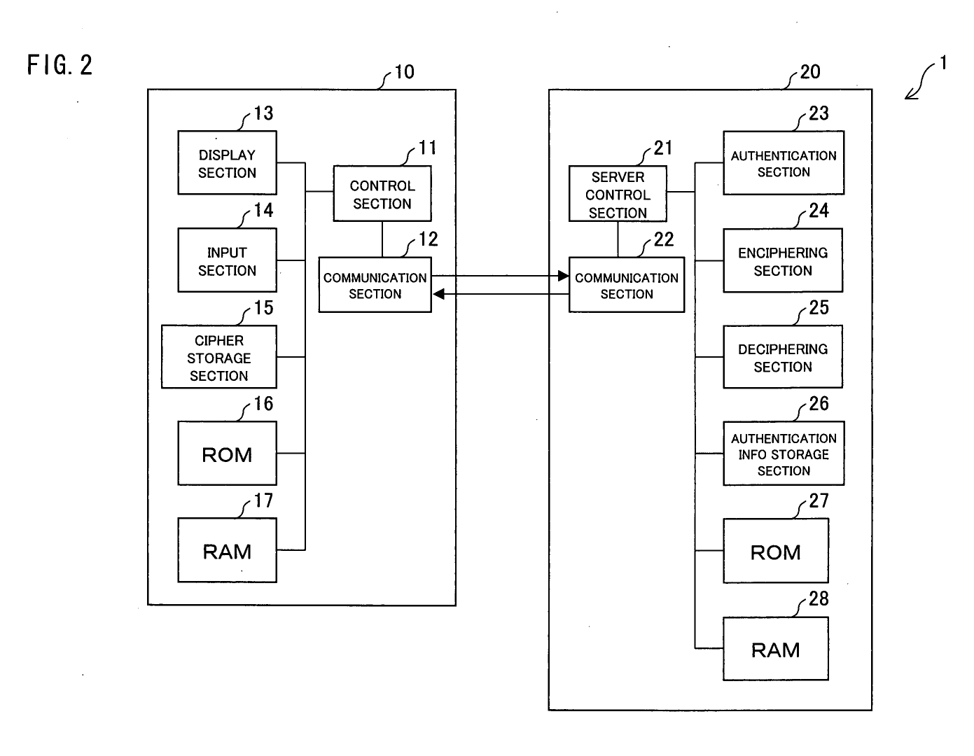

FIG. 2 is a block diagram schematically illustrating arrangements of the portable telephone 10 and the server 20.

The portable phone 10 is, as illustrated in FIG. 2, provided with a control section (using device control section) 11, a communication section 12, a display section 13, an input section 14, a cipher storage section 15, an ROM 16, and an RAM 17.

The control section 11 is a brain section of the portable telephone 10, and has a function of controlling operation of each component of the portable telephone 10.

ROM (Read Only Memory) 16 is a memory for storing therein various programs (such as a program for authentication process, and other programs) that the control section 11 uses.

RAM (Random Access Memory) 17 is a primary storage section used by the control section 11, and has a function of temporally storing various information that the control section 11 deals with. Moreover, when using a program stored in the ROM 16, the control section 11 loads from the ROM 16 to the RAM 17, the program to use.

The communication section 12 is used for externally communicating with a device connected to the portable phone 10 via the Internet. In the present embodiment, the portable phone 10 performs two-way communication with the server 20 via the communication section 12.

The display section 13 is for showing various information to the user by displaying the various information thereon. There is no particular limitation in display means used as the display section 13. An example of the display means used as the display section 13 is a liquid crystal display panel or the like.

The input section 14 is used for receiving various instructions from the user. The input section 14 provided to the portable telephone 10 is provided with plural keys (operation buttons). The user operates the keys in combination, thereby to input characters, number, symbols, or to select, from various processes, a process that the portable telephone 10 is to execute. The input section 14 is not limited to this arrangement, and various input means may be used as the input section 14. Examples of the input means that can be used as the input section 14 encompass: keyboards, mouse pointers, jog dials, pen input devices, touch panels, voice input devices, and other input devices. Moreover, the input means may be provided to the portable telephone 10, or may be connected to the portable telephone 10 wirelessly or via a cable.

The cipher storage section 15 has a function of storing ciphered information received from the server 20, that is, authentication information enciphered by the server 20. The authentication information may be user ID (user name), password, and/or the like.

The server 20 is, as illustrated in FIG. 2, provided with a server control (providing device control section) 21, a communication section 22, an authentication section 23, an enciphering section 24, a deciphering section 25, an authentication information storage section 26, an ROM 27, and an RAM 28.

The server control section 21 is a brain section of the server 20, and has a function of controlling operation of each component of the server 20.

ROM (Read Only Memory) 27 is a memory for storing therein various programs (such as a program for authentication process, and other programs) that the server control section 21 uses.

The RAM (Random Access Memory) 28 is a primary storage section used by the server control section 21, and has a function of temporally storing various information that the server control section 21 deals with. Moreover, when using a program stored in the ROM 27, the server control section 21 loads, from the ROM 27 to the RAM 28, the program to use.

The communication section 22 is used for externally communicating with a device connected to the server 20 via the Internet. In the present embodiment, the server 20 performs two-way communication with the portable phone 10 via the communication section 22.

The authentication information storage section 26 is for storing therein combination of the user ID and password preset for the user who is authorized to receive the service from the server 20 (The combination is non-enciphered authentication information). For example, the preset authentication information may be inputted (set) by using input means (not illustrated) provided to the server 20, or may be inputted (set) via the communication section 22 from an information processing terminal (portable telephone 10 in the present embodiment).

The authentication section 23 is used for performing authentication process to find out whether the user who is requesting the service from the information terminal device (portable telephone 10 in the present embodiment) connected via the communication section 22 is a user who is set (registered) in advance as a user authorized to receive the service. Specifically, the authentication section 23 matches (a) the user ID and password (non-enciphered authentication information) received from the information terminal device via the communication section 22, against (b) the preset authentication information stored in the authentication information storage section 26. If the matching showed that these information are identical, the authentication section 23 identifies, via the communication section 22, the user requesting for the service as the user authorized to receive the service.

The ciphering section 24 has a function of enciphering the authentication information received from the service using device via the communication section 22. How to encipher the authentication information is not particularly limited.

The deciphering section 25 has a function of deciphering the enciphered authentication information (enciphered authentication information) received from the service using device via the communication section 22.

Next, authentication process (how the portable telephone 10 and the server 20 operate in the authentication process) in the service providing system 1 is described below. In the following, it is assumed that the authentication information (user ID and password) of the user authorized to receive the service are registered (stored) in advance in the authentication information storage section 26 of the server 20.

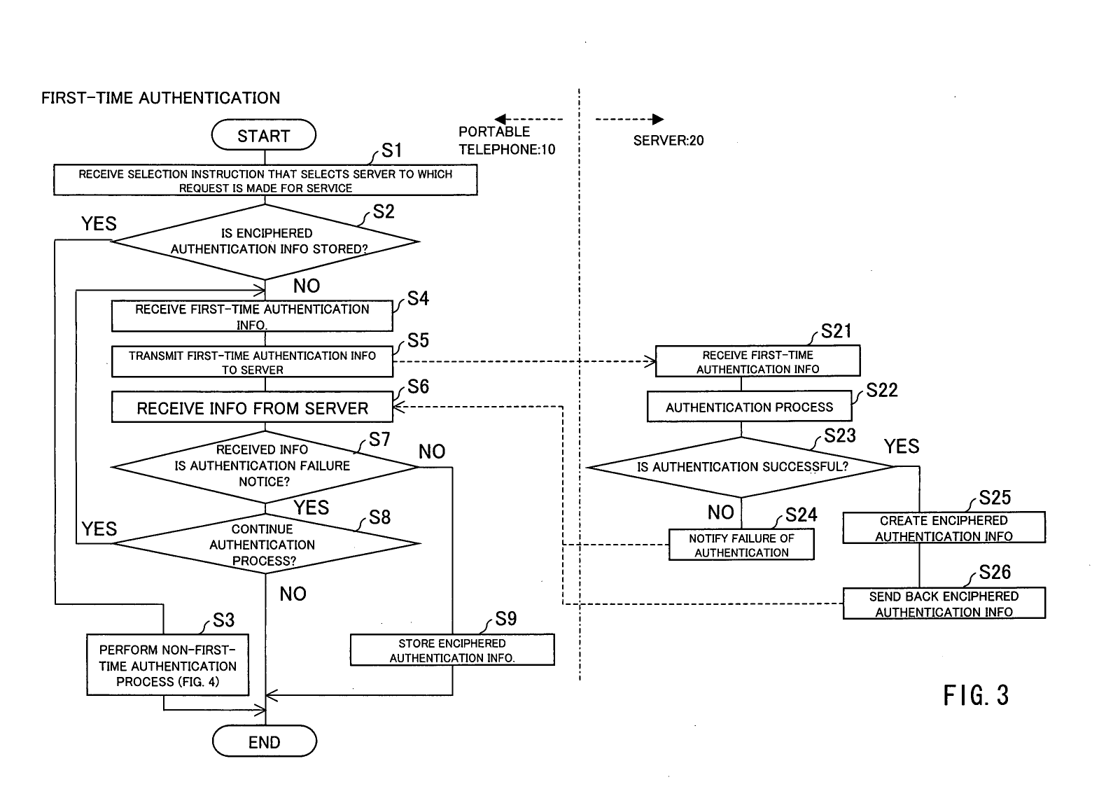

To begin with, first-time authentication process of the service providing system 1 is described below, referring to FIG. 3. FIG. 3 is a flow chart illustrating a flow of the first-time authentication process.

Firstly, the control section 11 of the portable telephone 10 receives a selection instruction that is to select a server 20 which the user requests to provide a service (S1), the selection instruction provided from the user via the input section 14. That is, the control section 11 receives the selection instruction to select the server 20 which the user requests to provide the service, from among the one or more servers 20 to which the portable telephone 10 can be connected via the network.

After receiving the selection instruction of the server 20 at S1, the control section 11 searches across the cipher storage section 15, thereby to judge whether enciphered authentication information corresponding to the selected server 20 (or enciphered authentication information corresponding to the requested service) is stored in the cipher storage section 15 (S2). Explanation on the enciphered authentication information is described later.

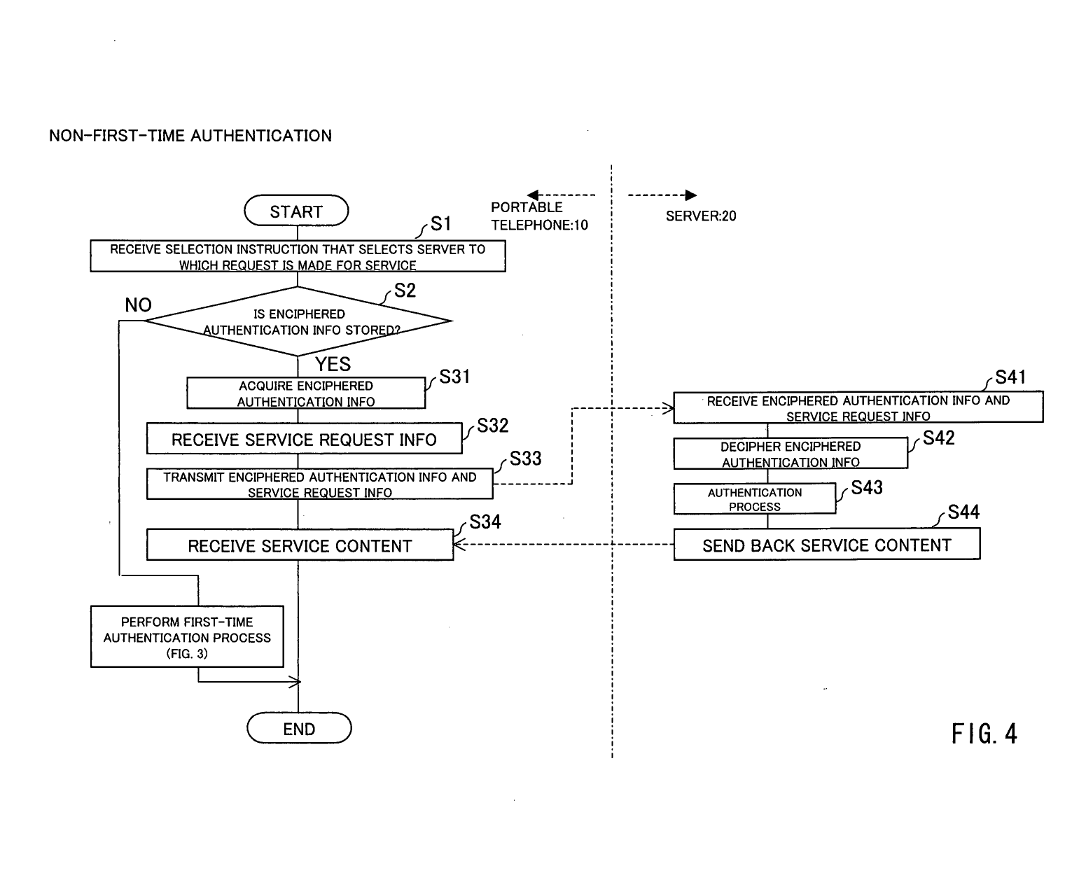

If the corresponding enciphered authentication information is stored in the cipher storage section 15, the first-time authentication process is not necessary. In this case, non-first-time authentication process (see FIG. 4) is carried out (S3). The non-first-time authentication process is explained later.

On the other hand, if it is judged that no corresponding enciphered authentication information is stored in the cipher storage section 15, the control section 11 performs the first-time authentication process explained below (process from S4 to S9 of the portable telephone 10, and process from S21 to S26 of the server 20).

In this case, the control section 11 receives first-time authentication information (user ID and password) provided from the user via the input section 14 (S4). In this case, if necessary, the control section 11 may be arranged to cause the display section 13 to display an image for requesting input of the first-time authentication information. Table 1 gives an example of authentication information (user ID and password) to be inputted via the input section 14.

TABLE 1

| | |
|---|---|
| User ID | hiratama |
| Password | a4@wer032 |

Next, to the server 20 to which the control section 11 requests to provide the service, the control section 11 transmits the first-time authentication information received at S4 (S5). At this stage, the first-time authentication information is non-enciphered authentication information, which is not ciphered.

The server control section 21 of the server 20 receives the first-time authentication information via the communicating section (service identification receiving section) 22, the first-time authentication information having been transmitted from the portable phone 10 (S21). After S21, the server control section 21 performs authentication process of the first-time authentication information (S22). Specifically, the first-time authentication information being received from the portable phone 10 is matched against the authentication information being set in advance and stored in the authentication information storage section 26.

From a result of the authentication process at S22 the server control section 21 judges whether or not the received authentication information matches the stored authentication information, that is, whether the authentication is successful or not (S23).

If it is judged, as S23, that the authentication is unsuccessful, the server control section 21 transmits, to the portable telephone 10, a signal (information) that informs the unsuccessful authentication, thereby to notify the portable telephone 10 of the unsuccessful authentication (S24).

On the other hand, if it is judged, as S23, that the authentication is successful, the server control section 21 causes the enciphering section 24 to encipher the authentication information, thereby to create the enciphered authentication information (S25). There is no particular limitation as to how to encipher the authentication information. Table 2 gives an example of the cipher authentication information created by enciphering the authentication information of Table 1 by the enciphering section 24.

TABLE 2

| | |
|---|---|
| User ID | %iIF3i)#Ro#$# |
| Password | %0g09j40-982 |

Next, via the communicating section 22 the server control section 21 transmits, back to the portable telephone 10, the enciphered authentication information thus created by the process of S25 (S26).

On the other hand, the control section 11 of the portable telephone 10 receives the information from the server 20 (S6). Then, the control section 11 judges whether or not the thus received information is the notice of the unsuccessful authentication (S7).

If it is judged that the thus received information is the notice of the unsuccessful authentication, that is, if it is judged that the thus received information is not the enciphered authentication information, the control section 11 causes the display section 13 to display to inform the failure of the authentication process, and to display an inquiry whether to continue the authentication process or not (the step of displaying the inquiry is not illustrated here). If an instruction not to continue the authentication process is inputted to the input section 14, or in no instruction is inputted to the input section 14, the authentication process is terminated. If an instruction to continue the authentication process is inputted to the input section 14, the process is repeated from S4. In an alternative, to continue the authentication process the user may input the first-time authentication information again while the input of the instruction to continue is omitted.

Moreover, if it is judged, at S7, that the received information is not the notice of the unsuccessful authentication, the control section 11 causes the cipher storage section 15 to store therein the thus received enciphered authentication information in association with information for identifying the server 20 corresponding to the enciphered authentication information (or information for identifying the service corresponding to the enciphered authentication information) (S9). In this way, the first-time authentication process is completed.

Referring to FIG. 4, the following describes non-first-time authentication process, that is, authentication process for a case where the cipher storage section 15 stores therein the enciphered authentication information corresponding to the requested service (or the enciphered authentication information corresponding to the server 20 that provides the requested service). FIG. 4 is a flow chart illustrating a flow of the non-first-time authentication process.

Firstly, the control section 11 of the portable telephone 10 performs S1 and S2 explained in FIG. 3. If it is judged, at S2, that the enciphered authentication information corresponding to the server 20 to be selected (or the enciphered authentication information corresponding to the requested service) is not stored, the control section 11 performs the first-time authentication process (the process from S4 in FIG. 3).

On the other hand, if it is judged, at S2, that the corresponding enciphered information is stored, the control section 11 performs the non-first-time authentication process explained below (process from S31 to S34 in the portable telephone 10, and process from S41 to S44 in the server 20).

In this case, the control section 11 retrieves the corresponding authentication information stored in the cipher storage section 15 (S31).

Next, the control section 11 receives an input of service request information via the input section 14 (S32). The service request information is various information necessary to request the service.

Next, the service request information thus received at S32 and the enciphered authentication information thus read out at S31 are transmitted via the communicating section 12 to the server 20 by the control section 11 (S33).

Table 3 gives examples of the enciphered authentication information and service request information. The examples are for requesting a service as to blog. In this example given in Table 3, URL of the blog to acquire and a service identifier are the service request information.

TABLE 3

| | |
|---|---|
| Service (Service Identifier) | Blog |
| User ID | %iIF3i)#Ro#$# |
| Password | %0g09j40-982 |
| URL of Blog to acquire | http://blog.yyy.zzz/newlog |

The server control section 21 of the server 20 receives the enciphered authentication information and the service request information via the communication section 22 from the portable telephone 10 (S41). Then, the server control section 21 causes the deciphering section 25 to decipher the enciphered authentication information thus received (S42).

Next, the server control section 21 performs authentication process for the authentication information thus deciphered (S43). Specifically, the server control 21 matches (a) the authentication information thus received from the portable telephone 10 and deciphered, against (b) the authentication information being set in advance and stored in the authentication information storage section 26. The thus deciphered authentication information is the authentication information with which the authentication is successful in the first-time authentication process. Therefore, unless the authentication information stored in the authentication information storage section 26 is rewritten, the thus deciphered authentication information matches the stored authentication information without fail. Here, it is assumed that the stored authentication information has not be rewritten. If the authentication information has been rewritten, the portable telephone 10 is notified of the unsuccessful authentication so as to start over again from the first-time authentication process (not illustrated).

After the authentication process is performed (the success of the authentication process is confirmed) at S43, the server control section 21 transmits service contents (contents of the service) to be provided to the portable telephone 10 (S44).

The control section 11 of the portable telephone 10 receives the service provided from the server 20 (S34). Then, the control section 11 performs necessary processes such as causing the RAM 17 to store the received contents; causing the display section 13 to display the received contents; and the like process. In this way, the non-first-time authentication process and non-first-time service contents receiving process are completed.

As described above, the present embodiment is arranged such that the server 20 receives the first-time authentication information from the portable telephone 10 and then performs the authentication process of the thus received first-time authentication information. If the first-time authentication is successful, the server 20 enciphers the first-time authentication information thereby to create the enciphered authentication information. Then, the server 20 transmits the enciphered authentication information to the portable telephone 10.

The portable telephone 10 receives the enciphered authentication information from the server 20 and stores the enciphered authentication information. To request for the service from the server 20 next time or later, the portable telephone 10 transmits, to the server 20, the enciphered authentication information thus stored therein, and the server 20 receives and deciphers the enciphered authentication information, and then performs the authentication process with the thus deciphered authentication information.

With this arrangement, the user of the portable telephone (service using device) 10 is only required to input the authentication information (user ID and password) in performing the first-time authentication process. That is, with this arrangement, it is unnecessary for the user to input the authentication information every time the user requests for the service provided from the server (service providing device) 20 by using the portable telephone 10. This allows the service to be provided more user-friendlily.

Moreover, because the authentication information stored in the portable telephone 10 has been enciphered, the authentication information with which the server 20 performs authentication will not be leaked (stolen), e.g., even if a storage region of the portable telephone 10 is analyzed. Therefore, the authentication method according to the present invention improves security (safety) of the authentication information.

The number of the server (service providing device) 20 which the portable telephone 10 can request to provide a service is not limited to one, even though the present embodiment discusses the case where the portable telephone 10 requests one server 20 to provide the service. That is, it is possible to arrange such that a server that provides a desired service is selected from among a plurality of servers 20 to which the portable telephone 10 can be connected via the network, and then the portable telephone 10 accessed to the thus selected server 20 thereby to request the thus selected server 20 to provide the desired service.

Moreover, in the case where the authentication method according to the present invention is realized between the portable telephone 10 and the plurality of servers 20, the authentication information (user ID and password) set in the servers 20 in advance may be different for every server 20 (or every service to be received).

Furthermore, in the present embodiment, the first-time authentication information (non-enciphered authentication information) is transmitted from the portable telephone 10 to the server 20 in the first-time authentication, and, if the authentication process performed by the server 20 is successful, the enciphered authentication information is transmitted back to the portable telephone 10 from the server 20. The present invention, however, is not limited to this arrangement. For example, the present invention may be arranged such that the first-time authentication information and the service request information are transmitted from the portable telephone 10 to the server 20, and the enciphered authentication information as well as the service contents are transmitted to the portable telephone 10 from the server 20.

Moreover, the present invention is not limited to the arrangement in which both of the user ID and the password are enciphered, even though the present embodiment discusses this arrangement. For example, the present invention may be arranged such that only one of the user ID and the password is enciphered.

Moreover, the present invention is not limited to the arrangement in which the user ID and the password are used as the authentication information, even though the present embodiment discuses this arrangement. For example, the present invention may be arranged such that a terminal ID, which each portable telephone (service using device) 10 individually has, may be used as the authentication information in addition to the user ID and password. Even if the enciphered authentication information is leaked to a third party, this arrangement prevents another information processing terminal (service using device) from receiving the service by using the leaked enciphered authentication information. Therefore, this arrangement provides better security as to the authentication information.

In this arrangement, the terminal ID can be any information specific to the terminal. For example, a telephone number, line service contract number, production number, of the portable telephone 10 may be used as the terminal ID. Because the terminal ID is individually specific to each portable telephone 10, it may be arranged that the control section 11 reads out the terminal ID stored, for example, in the ROM 16. In this arrangement, the user need not input the terminal ID. Moreover, in the arrangement in which the terminal ID is included in the authentication information, the terminal ID may be enciphered as well. Table 4 gives an example of the first-time authentication information to be transmitted from the portable telephone 10 to the server 20 in the first-time authentication process, where the terminal ID is a production number of the portable telephone 10.

TABLE 4

| User ID | hiratama |
|---|---|
| Password | a4@wer032 |
| Terminal ID | 037323290383 |

Moreover, the present embodiment is not limited to the arrangement of the present embodiment in which the first-time authentication information to be transmitted from the portable telephone 10 to the server 20 in the first-time authentication is the non-enciphered authentication information, which is not enciphered. For example, it may be arranged that the portable telephone 10 is provided with enciphering means and the server 20 is provided with deciphering means for the enciphering means, so that the first-time authentication information is performed such that the first-time authentication information is enciphered in the portable telephone 10 and then transmitted from the portable telephone 10 to the server 20 together with deciphering information that is for deciphering the enciphered authentication information. In this case, the enciphered first-time authentication information to be transmitted from the portable telephone 10 to the server 20 in the first-time authentication need not be the same as the enciphered authentication information that is to be transmitted from the server 20 to the portable telephone 10 after the successful first-time authentication.

Moreover, even though the present embodiment is arranged as such, the present invention is not limited to the arrangement in which the authentication information is enciphered after the successful first-time authentication process, and the enciphered authentication process is continuously used later on. For example, the enciphering process may be repeated every time the authentication process is successful in the non-first-time authentication process so that the enciphered authentication information different from a previous time is transmitted to the portable telephone 10. Moreover, every time the authentication process is repeated a certain number of times, the enciphered authentication information may be updated (re-enciphered) so that the enciphered authentication information different from the enciphered authentication information previously transmitted is transmitted to the portable telephone 10.

### Second Embodiment

Another embodiment of the present invention is described below, referring to drawings. For the sake of easy explanation, members having the same functions as the members described in the first embodiment are labeled in the same manner and their explanation is omitted here.

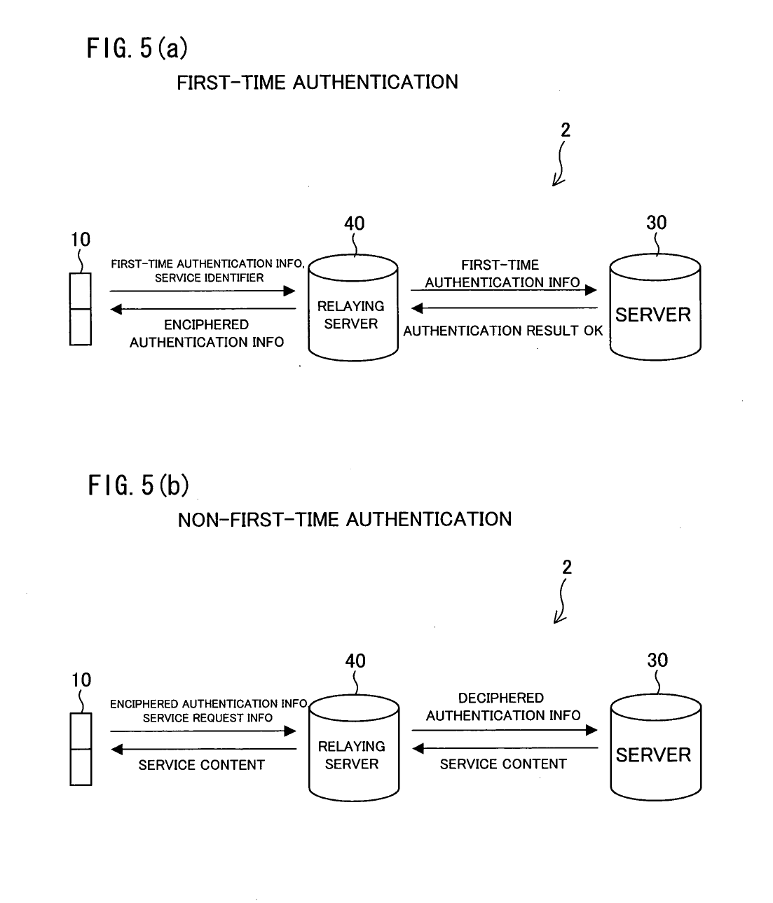

FIGS. 5(a) and 5(b) are explanation views schematically illustrating an arrangement of a service providing system 2 according to the present embodiment. As illustrated in FIGS. 5(a) and 5(b), the service providing system 2 is provided with a portable telephone (information terminal device) 10, a server (service providing device) 30, and a relaying server (service relaying device) 40. Moreover, (a) the portable telephone 10 and the relaying server 40, and (b) the relaying server 40 and the server 30 are connected with each other via a network such as the Internet or the like.

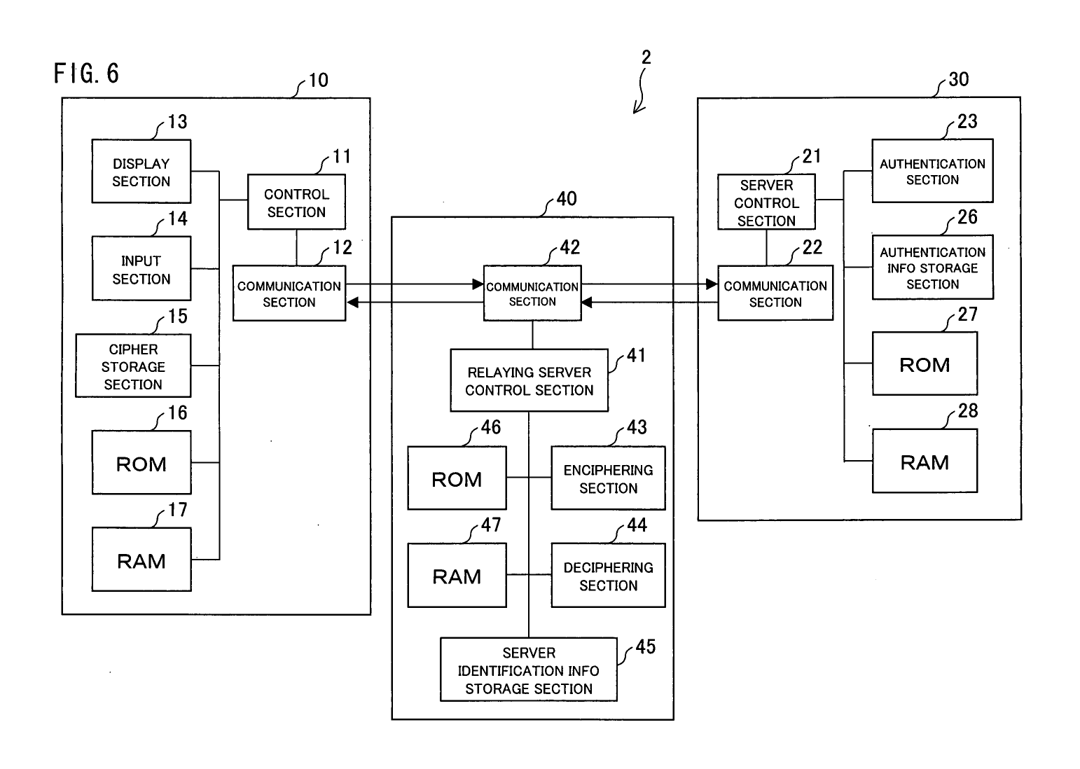

FIG. 6 is a block diagram schematically illustrating an arrangement of the portable telephone 10, the relaying server 40, and the server 30. The portable telephone 10 has an arrangement similar to that of the portable telephone 10 in the first embodiment.

The relaying server 40 is for relaying communication between the portable telephone 10 and the server 20. As illustrated in FIG. 6, the relaying server 40 is provided with the relaying server control section (relaying control section) 41, a communication section 42, an enciphering section 43, a deciphering section 44, a server identification information storage section 45, an ROM 46, and an RAM 47.

The relaying server control section 41 is a brain section of the relaying server 40 and controls operations of the components of the relaying server 40.

The ROM (Read Only Memory) 46 is a memory for storing various programs (programs for enciphering process, deciphering process, server authentication process, and the like) that the relaying server control section 41 uses.

The RAM (Random Access Memory) 47 is a primary storage section that is used by the relaying server control section 41. The RAM 47 temporarily stores therein various information that the relaying server control section 41 deals with. Moreover, when using a program stored in the ROM 46, the relaying server control section 41 loads, from the ROM 46 to the RAM 47, the program to use.

The communication section 42 is for communicating with the service using device (the portable telephone 10 in the present embodiment) and with the service providing device (the server 30 in the present embodiment), with which the server 40 is connected via the Internet. In the present embodiment, the relaying server 40 performs two-way communication with the portable telephone 10 and with the server 30 via the communication section 42.

The enciphering section 43 is for enciphering the authentication information received from the service using device via the communication section 42. There is no particular limit as to how to encipher the authentication information.

The deciphering section 44 is for deciphering the enciphered authentication information (enciphered authentication information) received from the service using device via the communication section 22.

The server authentication information storage section 45 is a storage for storing therein association of (a) destination(s) of one or more servers 30 connected with the relaying server 40 via the Internet, and (b) pieces of information (service identifiers) that respectively specify the services that the plural servers 30 provide respectively.

The server 30 is for providing a service via the relaying server 40 to the service using device (such as the portable telephone 10 or the like). The service that the server 30 provides is similar to the service that the server 20 provides in the first embodiment. Moreover, even though only one server 30 is illustrated in FIGS. 5(a) and 5(b), there are many servers 30 connected to the network, each of which provides a certain service respectively.

Note that the server 30 is different from the server 20 in the first embodiment in that the server 30 is not provided with an enciphering section and a deciphering section, and in that the communication section 22 does not communicate with the portable telephone 10, but with the relaying server 40.

Next, the authentication process in the service providing system 2 (i.e., operations of the portable telephone 10, relaying server 40, server 30 in the authentication process) is explained. It is assumed that the authentication information (User ID and password) of the user authorized to receive the service is registered (stored) in advance in the authentication information storage section 26 of the server 30.

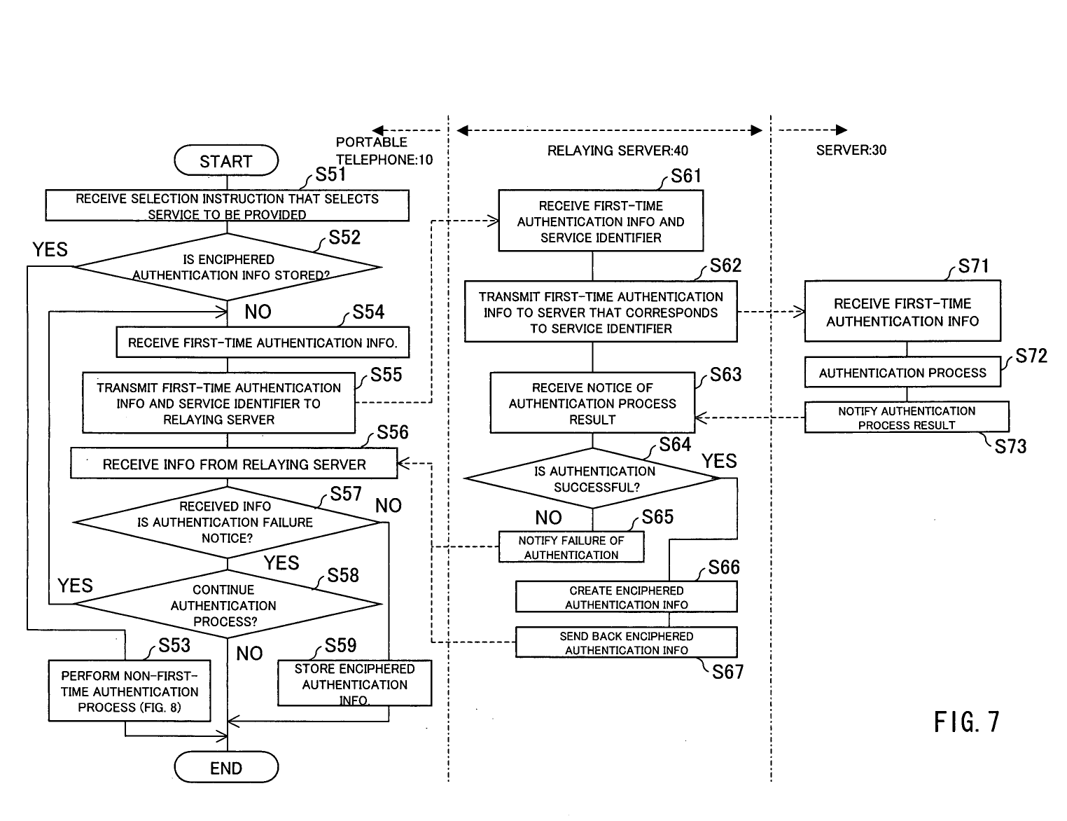

To begin with, first-time authentication process in the service providing system 2 is explained, referring to FIG. 7. FIG. 7 is a flow chart illustrating the first-time authentication process.

Firstly, the control section 11 of the portable telephone 10 receives a selection instruction that is to select a service to use (S51), the selection instruction provided via the input section 14 from the user. That is, the control section 11 receives the selection instruction that selects a desired service from among the service(s) provided from the one or more server 20 to which the portable telephone 10 can be connected via the network. The control section 11 creates information (service identifier) for specifying the selected service (not illustrated). Alternatively, the user may directly input, via the input terminal 14, the information (service identifier) for specifying the desired service.

Next, the control section 11 searches across the cipher storage section 15 in order to judge whether the enciphered authentication information corresponding to the service selected in S51 is stored in the cipher storage section 15 (S52).

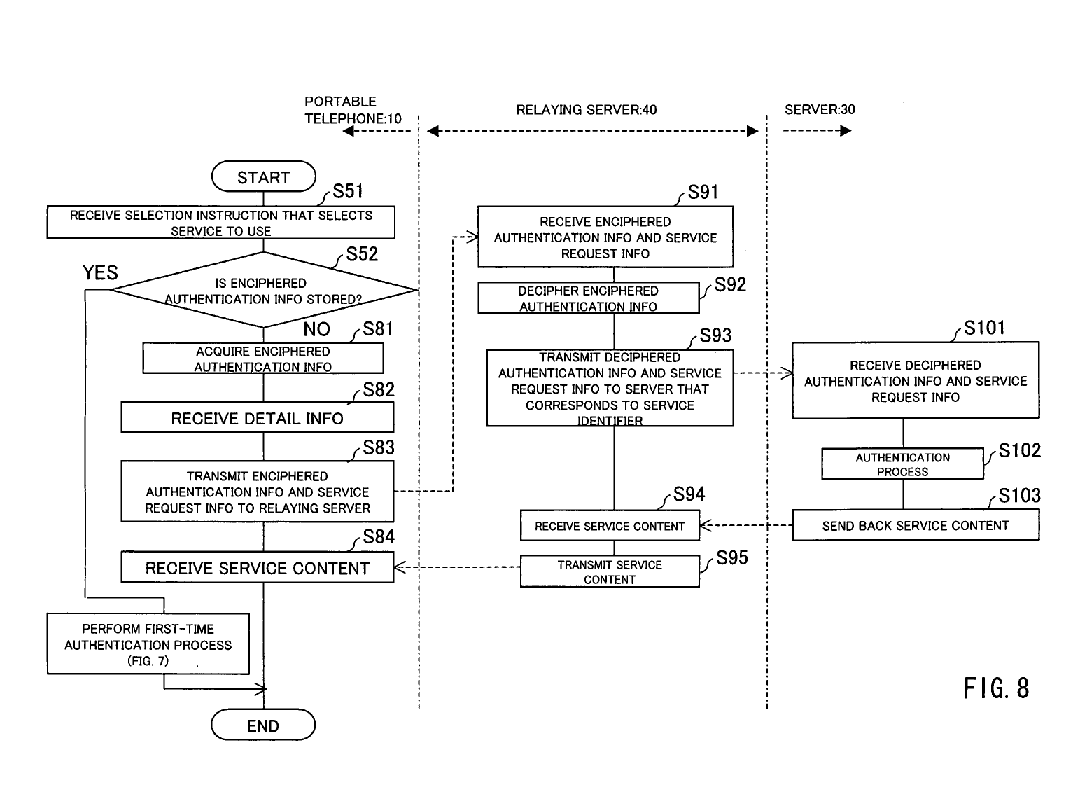

If the corresponding enciphered authentication information is stored in the enciphering storage section 15, later-described non-first-time authentication process (see FIG. 8) is carried out (S53), because no first-time authentication process is necessary.

On the other hand, if it is judged, at S52, that the corresponding enciphered authentication information is not stored in the enciphering storage section 15, the control section 11 performs the first-time authentication (process from S54 to S59 in the portable telephone 10, process from S61 to S67 in the relaying server 40, and process from S71 to S73 in the server 30) described below.

In this case, the control section 11 receives first-time authentication information (user ID and password) (S54), the first-time authentication information provided via the input section 14 from the user. In this case, if necessary, the control section 11 may cause the display section 13 to display an image for requesting for the input of the first-time authentication information.

Next, the control section 11 transmits the first-time authentication information and the service identifier to the relaying server 40 via the communication section 12 (S55). At this stage, the first-time authentication information is non-enciphered authentication information that is not enciphered. Table 5 gives an example of the information to be transmitted in S55. The example is a case where a blog providing service is requested.

TABLE 5

| | |
|---|---|
| Service (Service Identifier) | blog |
| User ID | hiratama |
| Password | a4@wer032 |

The relaying server control section 41 of the relaying server 40 receives the first-time authentication information and the service identifier (S61), the first-time authentication information and the service identifier transmitted from the portable telephone 10 via the communication section 42. By searching across the server authentication information storage section 45, the relaying server control section 41 finds out the destination of that server 30 which provides the service corresponding to the thus received service identifier, and then transmits the first-time authentication information to that server 30 via the communication section 42 (S62). Moreover, the relaying server control section 41 causes the RAM 47 to store the first-time authentication therein.

The server control section 21 of the server 30 receives the first-time authentication information via the communication section (service authentication receiving section) 22 (S71), the first-time authentication information transmitted from the relaying server 40. Then, the server control section 21 performs the authentication process for the first-time authentication information (S72). Specifically, the server control section 21 matches (a) the first-time authentication information thus received from the relaying server 40, against (b) the authentication information set in advance and recorded in the authentication information storage section 26. By doing this, the server control section 21 judges whether these pieces of the first-time authentication information match each other, that, is whether the authentication is successful or not. Then, the server control section 21 notifies the relaying server 40 of a result of the judgment (authentication process result) (S73).

On the other hand, the relaying server control section 41 of the relaying server 40 receives a notice of the authentication process result from the server 30 (S63). Then, the relaying server control section 41 judges whether the authentication process is successful or not in the server 30 (S64).

Here, if it is judged that the authentication process is unsuccessful, the relaying server control section 41 notifies the portable telephone 10 of the failure of the authentication (S65). On the other hand, if it is judged, at S64, that the authentication is successful, the relaying server control section 41 reads out the first-time authentication information stored in the RAM 47, and causes the enciphering section 43 to encipher the first-time authentication information, thereby to create enciphered authentication information (S66). There is no particular limitation as to how to encipher the first-time authentication information.

Next, the relaying server control section 41 transmits, to the portable telephone 10 via the communication section 42, the enciphered authentication information thus created by the process at S66 (S67).

On the other hand, the control section 11 of the portable telephone 10 receives the information transmitted back from the relaying server 40 (S56). Then, the control section 11 judges whether the thus received information is the notice of unsuccessful authentication (S57).

If it is judged that the received information is the notice of unsuccessful authentication, that is, if it is judged that the received information is not the enciphered authentication information, the control section 11 causes the display section 13 to display to inform that the authentication is unsuccessful and to make an inquiry whether to continue the authentication process (the step of displaying the inquiry is not illustrated here).

Then, the authentication process is terminated if an instruction not to continue the authentication process is given to the input section 14, or if no instruction is given. Moreover, if an instruction to continue the authentication process is given to the input section 14, the process from S54 is repeated. In an alternative, to continue the authentication process the user may input the first-time authentication information again while the input of the instruction to continue is omitted.

Moreover, if it is judged, at S57, that the received information is not the notice of the unsuccessful authentication, that is, if it is judged, at S57, that the received information is the enciphered authentication information, the control section 11 causes the cipher storage section 15 to store the thus received enciphered information in association with the service identifier corresponding to the enciphered authentication information (S59). In this way, the first-time authentication process is completed.

Next the non-first-time authentication, that is, authentication process for a case where the enciphered authentication information corresponding to the selected service is stored in the cipher storage section 15 is explained below referring to FIG. 8. FIG. 8 is a flow chart of the non-first-time authentication process.

To begin with the control section 11 of the portable telephone 10 performs the processes of S51 and S52 explained referring to FIG. 7. Then, if it is judged, at S52, that the enciphered authentication information corresponding to the service identifier of the selected service is not stored, the control section 11 performs the first-time authentication process (the process from S54 in FIG. 7).

On the other hand, if it is judged, at S52, that the corresponding enciphered information is stored, the control section 11 performs the non-first-time authentication process (process from S81 to S84 in the portable telephone 10, process from S91 to S95 in the relaying server 40, and process from S101 to S103 in the server 30) described below.

In this case, by reading out from the cipher storage section 15 where the enciphered authentication information is stored, the control section 11 acquires the enciphered authentication information that corresponds to the service identifier of the selected service (S81).

Next, the control section 11 receives, via the input section 14, an input of detail information regarding the service (S82). Here, in case of requesting for the service of providing a blog, the detail information of the service is, for example, URL or the like of the blog to acquire. Moreover, in case of requesting for the service of providing book information, the detail information of the service is, for example, information for specifying book whose information is requested for. In the following explanation, information containing the detail information as such and the service identification information is referred to as service request information.

Next, the control section 11 transmits the enciphered authentication information and the service request information to the relaying server 40 via the communication section 12 (S83), the enciphered authentication information being read out at S81, and the service request information containing (a) the detail information received at S82 and (b) the service identifier of the service selected at S51.

The relaying server control section 41 of the relaying server 40 receives the enciphered authentication information and the service request information via the communication section 42 from the portable telephone 10 (S91). Then, the relaying server control section 41 causes the deciphering section 25 to decipher the enciphered authentication information (S92).

Next, the relaying server control section 41 retrieves, from the server identification information storage section 45, the destination of the server 30 that provides the service corresponding to the service identifier received from the portable telephone 10, thereby to specify the destination of the server 30, and then the relaying server control section 41 transmits the deciphered authentication information and the service request information via the communication section 42 to the server 30 of the specified destination (S93).

The server control section 21 of the server 30 receives the deciphered authentication information and service request information from the relaying server 40 (S101). Then, the server control section 21 performs authentication process of the thus received authentication information (deciphered authentication information) (S102). Specifically, the authentication information deciphered in the relaying server 40 is matched against the authentication information set in advance and stored in the authentication information storage section 26. The thus deciphered authentication information is the authentication information with which the authentication is successful in the first-time authentication process. Therefore, unless the authentication information stored in the authentication information storage section 26 is rewritten, the thus deciphered authentication information matches the stored authentication information without fail. Here, it is assumed that the stored authentication information has not be rewritten. If the authentication information has been rewritten, the portable telephone 10 is notified of the unsuccessful authentication so as to start over again from the first-time authentication process (not illustrated).

After the authentication process of S102 is performed (after the success of the authentication is confirmed), the server control section 21 transmits, to the relaying server 40, service contents to be provided (S103).

The relaying server control section 41 of the relaying server 40 receives, from the server 30, the service contents to be provided (S94). Then the relaying server control section 41 transmits the service contents to the portable telephone 10 (S95).

The control section 11 of the portable telephone 10 receives the service contents from the relaying server 40 (S84). Then, the control section 11 performs necessary process, such as (a) causing the RAM 17 to store the service contents therein, (b) causing the display section 13 to display the service contents thereon, (c) and the like. In this way, the non-first-time authentication process and the non-first-time reception process of the service are completed.

As described above, in the present embodiment, the authentication information with which the first-time authentication process is successful is stored in the portable telephone 10 after enciphered in the relaying server 40. To request for the service next time or later, the portable telephone 10 transmits, to the relaying server 40, the enciphered authentication information thus stored. Then, the relaying server 40 receives and deciphers the enciphered authentication information. The deciphered authentication information is then transmitted to the server 30 that provides the service.

With this arrangement, the user of the portable telephone (service using device) 10 is only required to input the authentication information (user ID and password) in performing the first-time authentication process. That is, with this arrangement, it is unnecessary for the user to input the authentication information every time the user requests for the service provided from the server (service providing device) 30 by using the portable telephone 10. This allows the service to be provided more user-friendlily.

Moreover, because the authentication information stored in the portable telephone 10 has been enciphered, the authentication information with which the server 30 performs authentication will not be leaked (stolen), e.g., even if a storage region of the portable telephone 10 is analyzed. Therefore, the authentication method according to the present invention improves security (safety) of the authentication information.

Moreover, in the service providing system 2 according to the present embodiment, the relaying server 40 is provided with the enciphering section and deciphering section. This eliminates the necessity of providing the server 30 with an enciphering section and deciphering section. Therefore, the authentication method and the service providing system of the present invention can be realized by using the existing server 30 (service providing device).

Moreover, the relaying server 40 is provided with the server identification information storage section 45. As to the one or more servers to which the relaying server 40 can be connected, the server identification information storage section 45 stores, in association with the destination(s) of the one or more respective servers, the pieces of information (server identifiers) that respectively specify the service(s) that the one or more servers respectively provide. With this arrangement, the destination of the server that provides the service corresponding to the service identifier can be searched for in the relaying server 40 referring to the service identifier thus transmitted to the relaying server 40 from the portable telephone 10. That is, the portable telephone 10 is only required to store, in association with the service identifier, the enciphered authentication information of the service that is successful in the first-time authentication. Moreover, among services provided by plural servers, the user can easily use the service he desires, simply by selecting (inputting) the service he is to use (or the service identifier thereof).

Moreover, according to the present embodiment, the provision of the service relaying device allows the services of the plural service providing devices to be used with authentication that does not require inputting password every time. This allows the service to be provided more user-friendlily. Moreover, in case where the plural services are available respectively from the plural service providing devices, the different pieces of authentication information respectively set in the servers 30 (user ID and password) may be used for different servers (or every service) to use.

Moreover, in the present embodiment, for the first-time authentication, the first-time authentication information (non-enciphered authentication information) and the service identifier are transmitted to the relaying server 40 from the portable telephone 10. If the authentication process is successful in the server 30, the enciphered authentication information is transmitted back from the relaying server 40 to the portable telephone 10. However, the present embodiment is not limited to this. For example, the present invention may be arranged such that, for the first-time authentication, the detail information of the service to request is transmitted from the portable telephone 10 to the relaying server 40 as well as the first-time authentication information and the service identifier, and if the authentication process is successful in the server 30, (a) the service contents provided from the server 30 and (b) the enciphered authentication information created in the relaying server 40 are transmitted to the portable telephone 10 from the relaying server 40.

Moreover, the present invention may be arranged such that, for the first-time authentication, only one of the user ID and the password is enciphered. Moreover, the present invention may be arranged such that a terminal ID, which each portable telephone (service using device) 10 individually has, may be used as the authentication information in addition to the user ID and password. Moreover, the present invention may be arranged such that the portable telephone 10 is provided with enciphering means and the relaying server 40 is provided with deciphering means corresponding to the enciphering means, so that, for the first-time authentication, the first-time authentication information is enciphered in the portable telephone 10, and the enciphered first-time authentication information and deciphering information for deciphering the enciphered first-time authentication information are transmitted from the portable telephone 10 to the relaying server 40. In this case, the enciphered first-time authentication information to be transmitted from the portable telephone 10 to the relaying server 40 is not necessarily the same as the enciphered authentication information that the relaying server 40 creates after the successful first-time authentication.

Moreover, even though the present embodiment is arranged as such, the present invention is not limited to the arrangement in which the authentication information is enciphered after the successful first-time authentication process, and then the thus enciphered authentication information is continuously used thereafter. For example, the non-first-time authentication process may be arranged such that, every time a service is requested, the authentication process regarding the service is enciphered, so that enciphered authentication information different from last time is transmitted to the portable telephone 10. Moreover, the present invention may be arranged such that, every certain times the service is used, the enciphered authentication information is updated (enciphered again), so that enciphered authentication information different from last time is transmitted to the portable telephone 10.

### Third Embodiment

Still another embodiment of the present invention is explained. For the sake of easy explanation, members having the same function as the members explained in the first and second embodiments are labeled in the same manner and their explanation is omitted here.

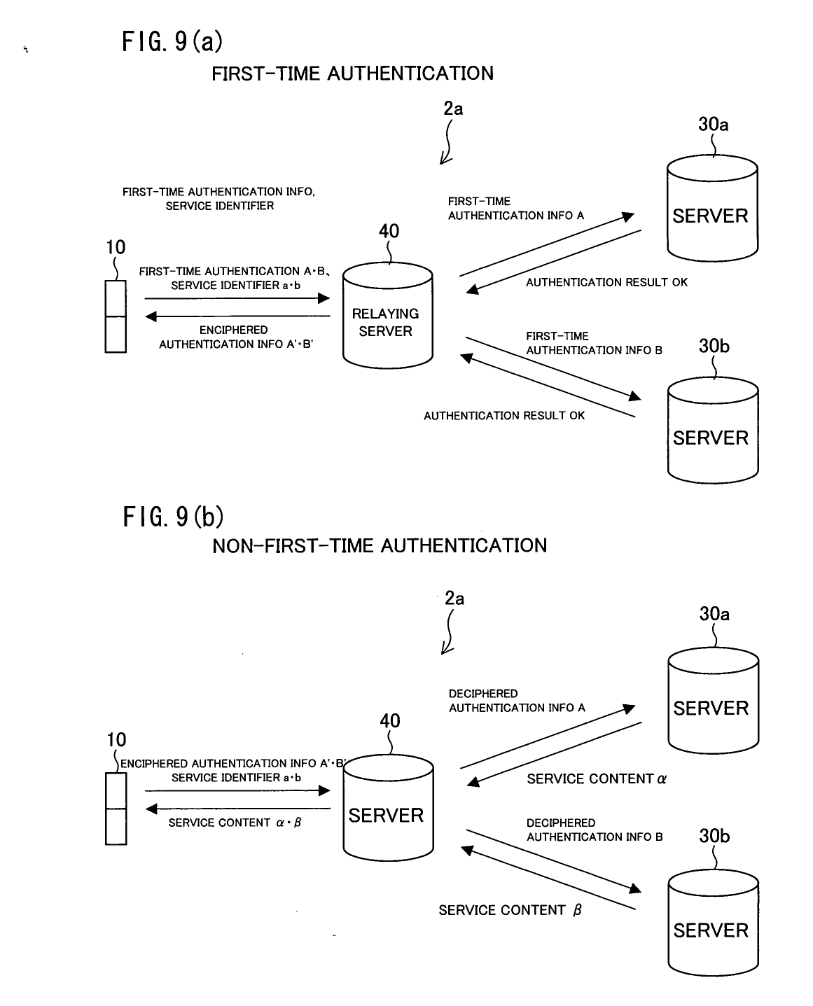

FIGS. 9(a) and 9(b) are explanatory views schematically illustrating the service providing system 2a according to the present embodiment. As illustrated in FIGS. 9(a) and 9(b), a service providing system 2a is provided with a portable telephone (information terminal device) 10, a relaying server (service relaying device) 40, and servers (service providing devices) 30a and 30b. (a) The portable telephone 10 and the relaying server 40, and (b) the relay server 40 and the servers 30a and 30b are respectively connected via a network such as the Internet or the like so that they can communicate with each other. Moreover, the portable telephone 10 has a similar arrangement to that in the first and second embodiments. The relaying server 40 has a similar arrangement to that in the second embodiment. The servers 30a and 30b has a similar arrangement to the server 30 in the second embodiment.

However, the present embodiment is arranged such that, in case the portable telephone 10 requests the plural servers (server 30a and 30b) to provide the services, a batch of pieces of authentication information to be transmitted respectively to the servers 30a and 30b is transmitted from the portable telephone 10 to the relaying server 40, and the pieces of authentication information thus received at the relaying server 40 are transmitted respectively to the servers 30a and 30b. Moreover, a batch of service contents provided from the servers 30a and 30b is transmitted to the portable telephone 10 by the relaying server 40.

Authentication process (operations of the portable telephone 10, relaying server 40, and servers 30a and 30b in the authentication process) in the service providing system 2a is explained below. In authentication information storage sections 26 of the servers 30a and 30b, authentication information (user ID and password) of a user authorized to receive the service is registered (stored) in advance.

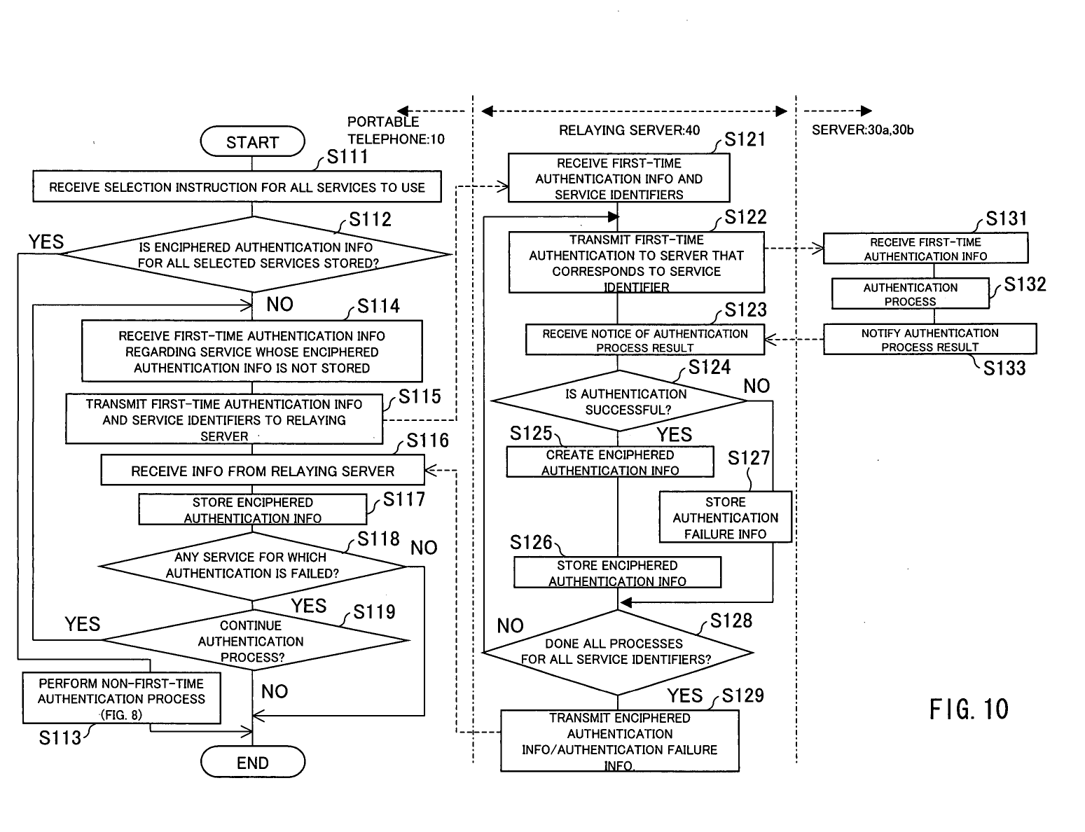

To begin with, first-time authentication process of the service providing system 2a is described below referring to FIG. 10. FIG. 10 is a flow chart illustrating the first-time authentication process.

Firstly, the control section 11 of the portable telephone 10 receives a selection instruction that is to select all services to use (S111), the selection instruction being provided from a user via an input section 14. That is, the control section 11 receives the selection instruction that selects all the desired services from among the services provided from one or more servers 20 to which the portable telephone 10 can be connected via the network. Then, the control section 11 generates pieces of information (service identifiers) for specifying the selected respective services (not illustrated). In an alternative, the pieces of information (service identifiers) respectively for specifying the services that the user desires may be inputted to portable telephone 10 directly via the input section 14.

Next, the control section 11 reads across the cipher storage section 15 and thereby judges whether or not each enciphered authentication information respectively corresponding to the services selected at S111 is stored in the cipher storage section 15 (S112).

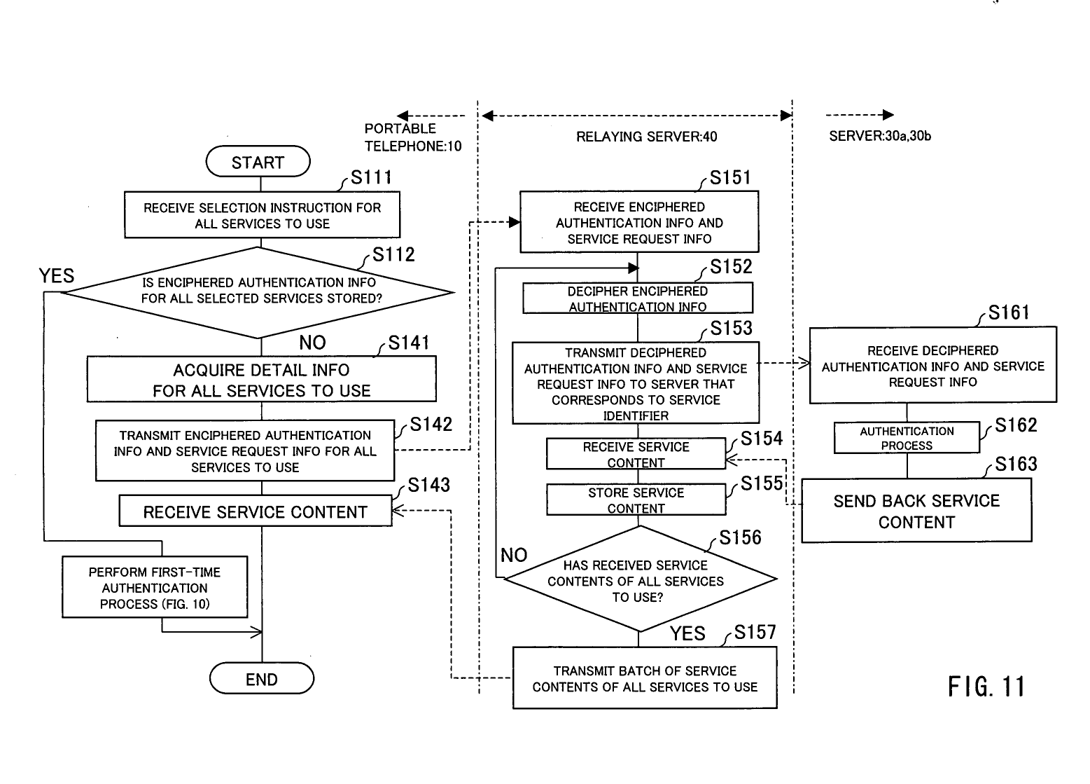

If the each enciphered authentication information is stored in the cipher storage section 15, no first-time authentication process is necessary, and later-described non-first-time authentication process (see FIG. 11) is carried out (S113).

On the other hand, if it is judged, at S112, that all the enciphered authentication information is not stored in the cipher storage section 15, the control section 11 performs the first-time authentication process described below (i.e., process from S114 to S119 in the portable telephone 10, process from S121 to S129 in the relaying server 40, and process from S131 to S133 in the servers 30a and 30b).

In this case, the control section 11 receives first-time authentication information (user ID and password) of that service which is judged at S112 that its enciphered authentication information is not stored (S114), the first-time authentication information being provided from a user via the input section 14. In this case, if necessary, the control section 11 may cause the display section 13 to display thereon an image for requesting input of the first-time authentication information of that service whose enciphered authentication information is not stored.

Next, to the relaying server 40 via the communication section 12, the control section 11 transmits the first-time authentication information inputted at S114 and the service identifiers of the service corresponding to the first-time authentication information (S115). At this stage, the first-time authentication information is non-enciphered authentication information that has not enciphered yet. Table 6 gives an example of the information to be transmitted at S115 in case where a blog providing service and a book (book information) providing service are used. In the example given in Table 6, the terminal ID which is information specific to each portable telephone 10 respectively is also used as the authentication information, in addition to the user ID and password.

TABLE 6

| | |
|---|---|
| Service Identifier a | Blog |
| User ID | hiratama |
| (First-time Authentication Information A) | |
| Password | a4@wer032 |
| (First-time Authentication Information A) | |
| Terminal ID | 037323290383 |
| (First-time Authentication Information A) | |
| Service Identifier b | Book Information |
| User ID | tama |
| (First-time Authentication Information B) | |
| Password | 234tyu59k |
| (First-time Authentication Information B) | |
| Terminal ID | 037323290383 |
| (First-time Authentication Information B) | |

The relaying server control section 41 of the relaying server 40 receives all the first-time authentication information and the service identifiers respectively regarding all the services to use (S121), the first-time authentication information and the service identifiers being transmitted from the portable telephone 10 via the communication section 42. Then, the relaying server control section 41 retrieves, from the server identification information storage section 45, destinations of the servers that provide the services corresponding to the thus received service identifiers, thereby to specify the destinations of the servers. Then, the relaying server control section 41 transmits the first-time authentication information to the server of the thus specified destination of via the communication section 42 (S122). Moreover, the relaying server control section 41 causes the RAM 47 to store therein the first-time authentication information of the respective services. For example, in case where the blog providing service is used as in Table 6, first-time authentication information as illustrated in Table 7 is transmitted to the server 30a that provides the blog providing service.

TABLE 7

| | |
|---|---|
| User ID | hiratama |
| (First-time Authentication Information A) | |
| Password | a4@wer032 |
| (First-time Authentication Information A) | |
| Terminal ID | 037323290383 |
| (First-time Authentication Information A) | |

Moreover, in case where the book information providing service is used as illustrated in Table 6, first-time authentication information as illustrated in Table 8 is transmitted to the server 30b that provides the book information providing service.

TABLE 8

| | |
|---|---|
| User ID | tama |
| (First-time Authentication Information B) | |
| Password | 234tyu59k |
| (First-time Authentication Information B) | |
| Terminal ID | 037323290383 |
| (First-time Authentication Information B) | |

The control sections 21 of the servers 30a and 30b receive the first-time authentication information transmitted from the relaying server 40 via the communication section (service identification receiving section) 22 (S131). Then, the servers 30a and 30b perform authentication process for the thus received first-time authentication information (S132). More specifically, the control sections 21 match (a) the first-time authentication information thus received from the relaying server 40 against (b) the authentication information set in advance and stored in the authentication information storage section 26. Thereby, the control sections 21 judge whether or not the pieces of information match with each other, that is, whether the authentication is successful or not. Then, each server control section 21 gives, to the relaying server 40, a notice of a result of the judgment (authentication process result) (S133).

The relaying server control section 41 of the relaying server 40 receives the notices of the authentication process result from the server 30a and 30b (S123). Then, the relaying server control section 41 judges whether the authentication process is successful respectively in the servers 30a and 30b (S124).

The relaying server control section 41 reads out, from the RAM 47, first-time authentication information of that service for which it is judged that the authentication process for that service is successful. Then, the relaying server control section 41 causes the enciphering section 43 to encipher the first-time authentication information, thereby to create enciphered authentication information (S125). Moreover, the relaying server control section 41 causes the RAM 47 to store the thus created enciphered authentication information therein (S126).

On the other hand, as to that service which is judged at S124 that authentication process for that service is unsuccessful, the relaying server control section 41 causes the RAM 47 to store therein authentication failure information that informs the unsuccessful authentication process for the service (S127).

After that the relaying server control section 41 judges whether or not the authentication process for all the services respectively corresponding to the service identifiers to use has been completed (S128), the service identifiers being received from the portable telephone 10. If there is still a service for which the authentication process has not been completed, the process from S122 is repeated until the authentication process for all the services is completed. On the other hand, if the authentication process for all the service to use has been completed, the relaying server control section 41 reads out the enciphered authentication information stored in RAM 47 at S126 and the authentication failure information stored in the RAM 47 at S127. Then, the relaying server control section 41 transmits a batch of the thus read out information to the portable telephone 10 (S129).

Table 9 gives an example of information (service identifier and enciphered authentication information) to be transmitted from the relaying server 40 to the portable telephone 10. The information is information for a case where the authentication process is successful both in the blog providing service and the book information providing service. In this example, the terminal ID is not enciphered. However, the present invention is not limited to the arrangement the terminal ID is not enciphered.

TABLE 9

| | |
|---|---|
| Service Identifier a | blog |
| User ID | %iIF3i)#Ro#$# |
| (First-time Authentication Information A′) | |
| Password | %0g09j40-982 |
| (First-time Authentication Information A′) | |
| Terminal ID | 037323290383 |
| (First-time Authentication Information A′) | |
| Service Identifier b | book information |
| User ID | %41bs09ETIJ9 |
| (First-time Authentication Information B′) | |
| Password | %23E34GDRo |
| (First-time Authentication Information B′) | |
| Terminal ID | 037323290383 |
| (First-time Authentication Information B′) | |

The control section 11 of the portable telephone 10 receives the information being sent back from the relaying server 40 (S116). Then, the control section 11 causes the enciphered storage section 15 to store therein (a) the enciphered authentication information contained in the thus received information in association with (b) the service identifier for the enciphered authentication information (S117).

Next, the control section 11 judges whether or not the authentication failure information is contained in the information thus received from the relaying server 40 (S118). If it is judged that the authentication failure information is contained in the information, the control section 11 causes the display section 13 to display thereon to notify the failure of the authentication process of the service and to inquire whether to continue the authentication process (the step of displaying is not illustrated).

If the input section 14 receives an instruction not to continue the authentication process, or if the input section 14 receives no instruction, the control section 11 judges that it is given up to use the service. Accordingly the control section 11 terminates the authentication process. Moreover if the input section 14 receives an instruction to continue the authentication process, the process from S114 is repeated again. In an alternative, while omitting the input of the instruction to continue the authentication process, the user may input the first-time authentication information for the service again, in order to continue the authentication process.

Moreover, if it is judged at S118 that the thus received information does not contain the authentication failure information, that is, if all the information thus received are the enciphered authentication information, the control section 11 terminates the first-time authentication process.

Next, referring to FIG. 11, the following explains the non-first-time authentication process, that is, the authentication process for a case where the pieces of enciphered authentication information respectively corresponding to all the selected services are stored in the cipher storage section 15. FIG. 11 is a flow chart illustrating a flow of the non-first-time authentication process.

To begin with the control section 11 of the portable telephone 10 performs the process from S11 to S112, which is explained referring to FIG. 10. Then, if it is judged at S112 that all pieces of the enciphered authentication information corresponding respectively to all the service to use are not stored in the cipher storage section 15, the control section 11 performs the first-time authentication process (the process from S114 in FIG. 10).

On the other hand, if it is judged at S112 that the corresponding enciphered information is stored, the control section 11 performs the non-first-time authentication process (process from S141 to S143 in the portable telephone 10, process from S151 to S157 in the relaying server 40, and process from S161 to S163 in the relaying server 40) described below.

In this case, the control section 11 receives an input of detail information (other information) regarding the service, the input of detail information being inputted via the input section 14. Here, in case where a blog providing service is to be requested, the detail information regarding the service may be, for example, URL of a blog to acquire. Moreover, in case where a book information providing service is to be requested, the detail information regarding the service may be, for example a number for specifying the book to acquire. In the following, the information containing the detail information and the service identification information is referred to as service request information.

Next, the control section 11 reads out, from the cipher storage section 15, the pieces of enciphered authentication information that correspond to the service identifiers of all the services to use. Then, the control section 11 transmits, to the relaying server 40 via the communication section 12, (a) the pieces of enciphered authentication information thus read out, the pieces of enciphered authentication information respectively regarding all the services to use and (b) the pieces of service request information respectively regarding the services (the service identifiers of the services and the pieces of detail information of the services) (S142). FIG. 10 gives an example of information to be transmitted by process at S142.

TABLE 10

| | |
|---|---|
| Service Identifier a | Blog |
| User ID (EAI A′) | %iIF3i)#Ro#$# |
| Password (EAI A′) | %0g09j40-982 |
| Terminal ID (EAI A′) | 037323290383 |
| Detail information | http://blog.yyy.zzz/newlog |
| | (URL of blog to acquire) |
| Service Identifier b | Book Information |
| User ID (EAI B′) | %41bs09ETIJ9 |
| Password (EAI B′) | %23E34GDRo |
| Terminal ID (EAI B′) | 037323290383 |
| Detail information | 9784320027039 |
| | (Book Number) |

Abbreviation:
EAI A′ stands for Enciphered authentication information A′; and
EAI B′ stands for Enciphered authentication information B′.

Abbreviation:

EAI A′ stands for Enciphered authentication information A′; and

EAI B′ stands for Enciphered authentication information B′.

The relaying server control section 41 of the relaying server 40 receives the pieces of enciphered authentication information and service request information via the communication section 42 from the portable telephone 10, the pieces of enciphered authentication information and service request information regarding all the services to use. (S151). Then, the relaying server control section 41 causes the deciphering section 25 to decipher each piece of the enciphered authentication information thus received (S152).

Next, the relaying server control section 41 retrieves, from the server authentication information storage section 45, destinations of the servers that respectively provide the services to use. Thereby, the relaying server control section 41 specifies the servers that respectively provide the services to use. Then, via the communication section 42, the relaying server control section 41 transmits the thus deciphered authentication information and the detail information regarding the service to the thus specified servers (S153).

That is, to the server 30a that provides the blog providing service, the relaying server control section 41 transmits the deciphered authentication information and the detail information regarding the services, as illustrated in Table 11.

TABLE 11

| | |
|---|---|
| User ID | hiratama |
| Password (DAI A) | a4@wer032 |
| Terminal ID (DAI A) | 037323290383 |
| Detail information | http://blog.yyy.zzz/newlog |
| | (URL of blog to acquire) |

Abbreviation:
DAI A stands for deciphered authentication information A.

Moreover, to the server 30b that provides the blog providing service, the relaying server control section 41 transmits the deciphered authentication information and the detail information regarding the services, as illustrated in Table 12.

TABLE 12

| | |
|---|---|
| User ID | tama |
| Password (DAI B) | 234tyu59k |
| Terminal ID (DAI B) | 037323290383 |
| Detail information | 9784320027039 |
| | (Book Number) |

Abbreviation:
DAI B stands for deciphered authentication information B.

The server control sections 21 of the servers 30a and 30b receive the deciphered authentication information and the service request information from the relaying server 40 (S161). Then, the server control sections 21 performs authentication process of the thus received authentication information (deciphered authentication information) (S162). More specifically, the server control sections 21 match (a) the authentication information thus deciphered in the relay server 40 against (b) the authentication information being set in advance and stored in the authentication information storage section 26. The deciphered authentication information is the authentication information that has been successful in the authentication in the first-time authentication process. Thus, as long as the authentication information stored in the authentication information storage section 26 has been rewritten, the authentication information thus deciphered in the relay server 40 matches against (b) the authentication information stored in the authentication information storage section 26. Here, it is assumed that such rewritten is not performed. If the authentication information stored in the authentication information storage section 26 has been rewritten, the server control section 21 notifies the portable telephone 10 of unsuccessful authentication via the relaying server 40, and repeats the process from the first-time authentication process (the repeating is not illustrated).

After the authentication process at S162 (i.e., after the authentication success is confirmed), the server control section 21 transmits, to the relaying server 40, service contents to be provided (S163). In FIG. 9(b), service contents to be transmitted from the server 30a that provides a blog is referred to as service content a, while service contents to be transmitted from the server 30b that provides a book information is referred to as service content β.

The relaying server control section 41 of the relaying server 40 receives the service contents provided from the servers 30a and 30b (S94). Then, the relaying server control section 41 causes the RAM 47 to store therein the thus received service contents in association with the service identifiers of the respective services (S155).

After that, the relaying server control section 41 judges whether or not the relaying server control section 41 receives service contents of all the services corresponding to all the service identifiers to use (S156). Then, if there is a service whose service contents the relaying server control section 41 has not yet received, the relaying server control section 41 repeats the process from S152 until it receives the service contents of all the services.

On the other hand, if it is judged that the service contents of all the services to use has been received, the relaying server control section 41 reads out those service contents of the respective services which are stored in the RAM 47 at S155, and transmits a batch of the thus read-out service contents of the respective services to the portable telephone 10 (S157), the service contents of the respective services being transmitted respectively in association with the service identifiers of the respective services.

The control section 11 of the portable telephone 10 receives the service contents from the relaying server 40 (S143). Then, the control section 11 performs necessary processes, such as causing RAM 17 to store the service contents thus received, causing the display section 13 to display the service contents thus receives, etc. In this way, the non-first-time authentication process and the non-first-time reception process of the service are completed.

To request, by using the portable telephone 10 (service using device), the respective plural servers 30a and 30b (service providing devices) to provide their services, the service providing system 2a according to the present embodiment, as described above, has the following arrangement: a batch of pieces of authentication information to be transmitted respectively to the servers 30a and 30b is transmitted from the portable telephone 10 to the relaying server 40 (service relaying device), and the relaying server 40 transmits, respectively to the servers 30a and 30b, the respective pieces of authentication information thus received.

Therefore, if he wants to use plural services (in case of first-time authentication), the user can receive the plural services he wants, by inputting a batch of the respective pieces authentication information regarding the respective services, and causing transmission of the batch of the respective pieces authentication information to the relaying server 40. This arrangement improves the first-time authentication for the services to be provide more user-friendlily.

The authentication information (e.g., the user IDs and passwords) for the services may be common authentication information that is common to the plural services, or may be different for different services.

Moreover, the service providing system 2a is arranged such that the service contents provided from the servers 30a and 30b are transmitted in batch to the portable telephone 10 by the relaying server 40. With this arrangement, the services provided respectively from the plural servers can be used concurrently or in combination by the user.

Moreover, as to one or more servers that are so connected with the relaying server 40 that the one or more servers can communicate with the relaying server 40, there is a piece(s) of the information (service identifier(s)) that specifies/specify the service(s) that the one or more servers provide. The relay server 40 is provided with the server identification information storage section 45 for storing the piece(s) of the information (service identifier(s)) in association with destination(s) of the one or more servers. With this arrangement, a destination of that server which provides the service corresponding to the service identifier can be searched in the relaying server 40 by referring to the service identifier transmitted from the portable telephone 10 to the relaying server 40. That is, the portable telephone 10 is only required to store the enciphered authentication information for the service for which the first-time authentication is successful, in a manner that the enciphered authentication information is stored in association with the service identifier for the service. Moreover, simply by selecting (inputting) a service he wants to use (or inputting service identifier of the service) the user can readily use the desired service from among services respectively provided from plural servers.

### Fourth Embodiment

Still yet another embodiment of the present invention is explained below. For the sake of easy explanation, members having the same function as the members described in the first to third embodiments are labeled in the same manner and their explanation is omitted here.

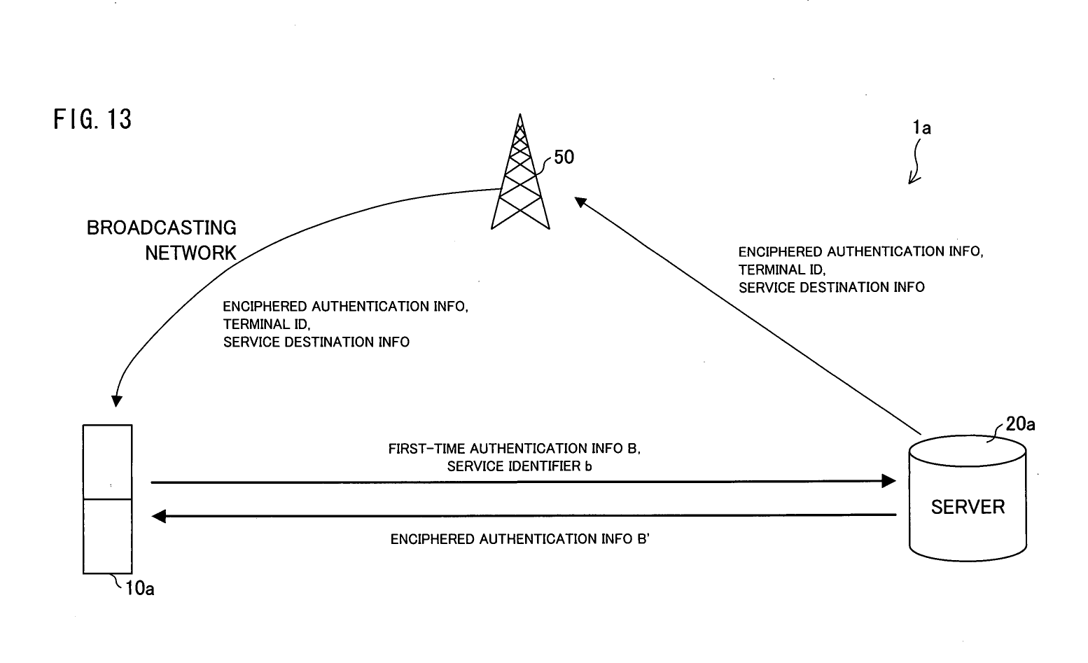

FIG. 13 is an explanation view schematically illustrating an arrangement of a service providing system 1a according to the present embodiment. As illustrated in FIG. 13, the service providing system 1a is provided with a portable telephone (information terminal device, a service using device) 10a and a server (service providing device) 20a. The portable telephone 10a and the server 20a are connected via a network such as the Internet so that they can communicate with each other. Moreover, the service providing system 1a is arranged such that enciphered authentication information of a user authorized to receive a service, a terminal ID, and information regarding destination to connect to receive the service (hereinafter, this information is referred to as service destination information) are transmitted from the server 20a to a broadcasting base station 50 via the Internet or the like, and then transmitted from the broadcasting base station 50 via a broadcasting network. Here, the broadcasting network may be, for example, a digital terrestrial television broadcasting, BS (broadcasting satellite) digital broadcasting, mobile broadcasting, broadcasting for portable telephones, or the like broadcasting.

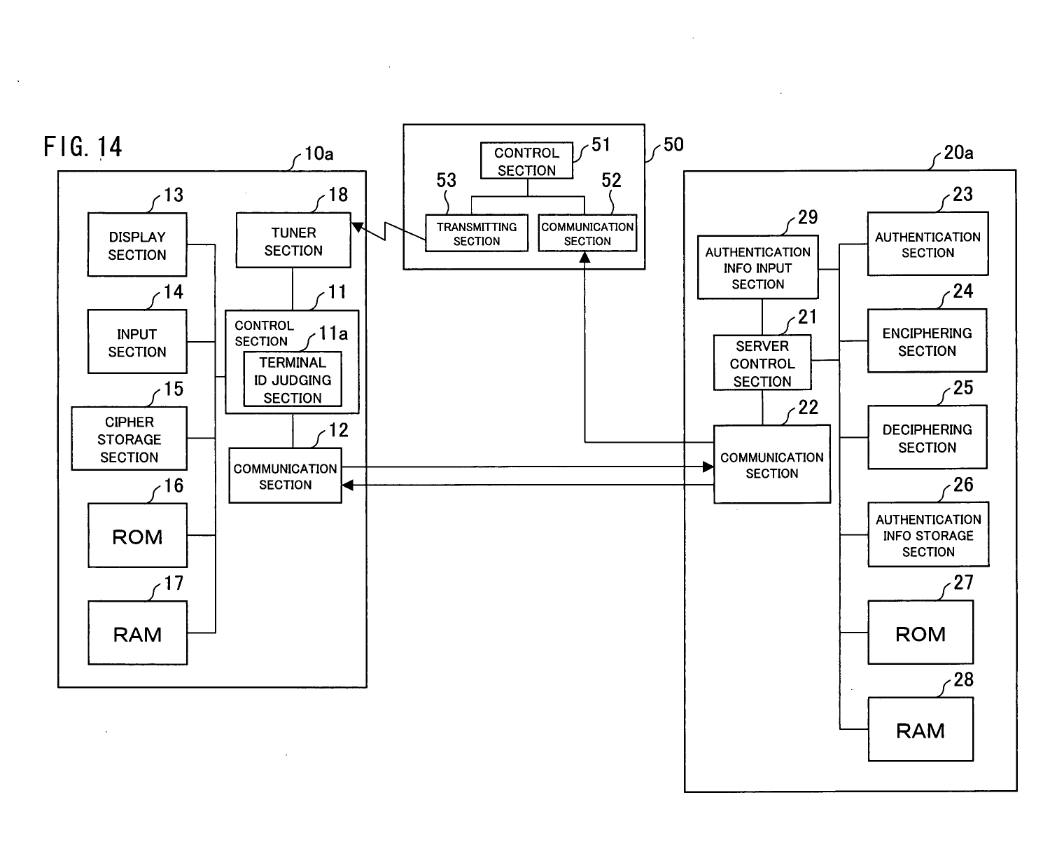

FIG. 14 is a block diagram schematically illustrating the portable telephone 10a, server 20a, and broadcasting base station 50.

The broadcasting base station 50 is provided with a control section 51, a communication section 52, and a transmitting section 53. The control section 51 is for controlling operation of the communication section 52 and the transmitting section 53. The communication section 52 is for performing communication with a communication section 22 provided to the server 20a. There is no particular limitation as to a communication medium through which the communication section 52 and the communication section 22 are connected with each other so that they can communicate with each other. An example of the communication medium is the Internet or the like.

The portable telephone 10a, which has the same arrangement as the portable telephone 10 illustrated in FIG. 2, is further provided with a tuner section 18 for receiving a broadcast transmitted from the broadcasting base station 50. Moreover, the control section 11 of the portable telephone 10a is provided with a terminal ID judging section 11a for judging whether or not information received via the tuner section 18 contains a terminal ID of the portable telephone 10a.

The server 20a, which has the same arrangement as the server 20 illustrated in FIG. 2, is further provided with an authentication information input section 29. The authentication information input section 29 receives an input of (a) a user ID of the user who is authorized to receive the service from the server 20a, (b) password, and (c) the terminal ID of the portable telephone 10a to which the service is to be provided. The authentication information input section 29 is not particularly limited in terms of its arrangement, and may be any kind of input means such as a keyboard, mouse pointer, jog dial, pen input device, touch panel, voice input device, or the like. The input means may be provided to the portable telephone 10a or connected to the portable telephone 10a wirelessly or via a cable.

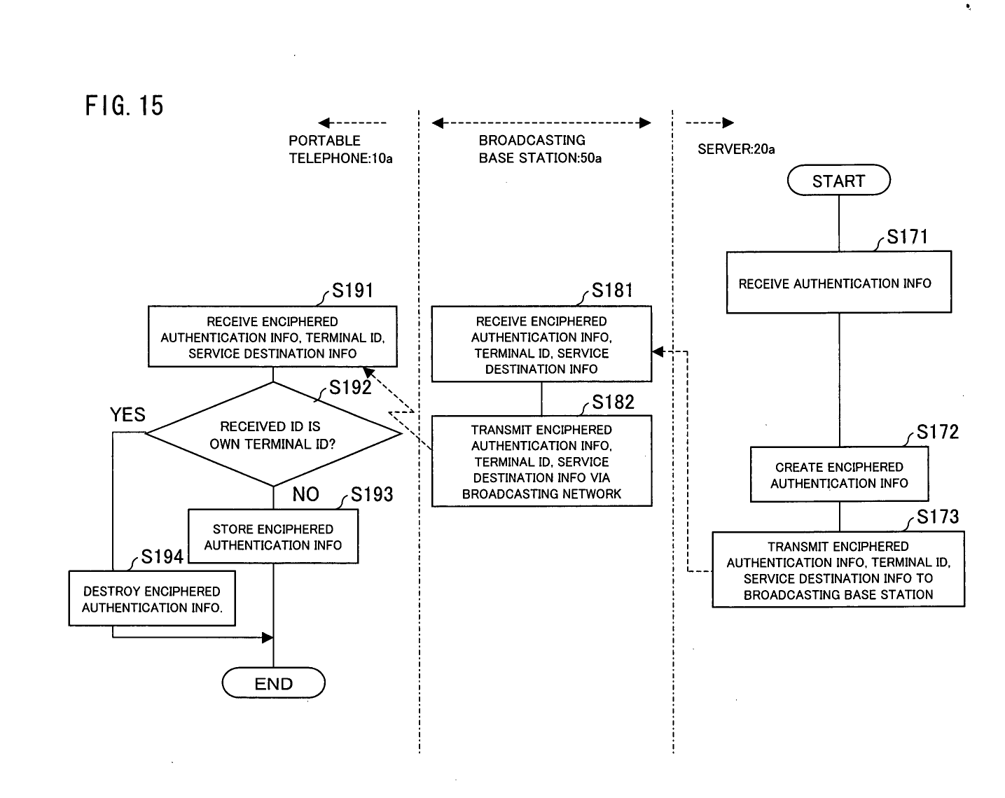

Next, operations of the portable telephone 10a and server 20a in the service providing system 1a are explained below. FIG. 15 is a flow chart illustrating a flow of first-time authentication process of the service providing system 1a.

The server control section 21 of the server 20a receives an input of authentication information (user ID, password, terminal ID) inputted via the authentication information input section 29 (S171), the authentication information being authorized for the service. For example, authentication information of a user who has signed on for the service is provided into the authentication information input section 29 from a service providing party.

Next, the server control section 21 causes an enciphering section 24 to encipher authentication information inputted at S171, thereby to create enciphered authentication information (S172). There is not limitation as to how to encipher the authentication information.

Next, via the communication section 22, the server control section 21 transmits, to the broadcasting base station 50, the enciphered authentication information created at S172 and the terminal ID and the service destination information (an address to communicate with the server 20a) inputted at S171 (S173). Table 13 give an example of the enciphered authentication information (user ID and password) to be transmitted from the server 20a to the broadcasting base station 50, terminal ID, and service destination information.

TABLE 13

| | |
|---|---|
| User ID | %IF3i)#Ro#$# |
| Password | %0g09j40-982 |
| Terminal ID | 037323290383 |
| Service Destination information | http://aaa.bbb.ccc/ |

The control section 51 of the broadcasting base station 50 receives the enciphered authentication information, terminal ID, and service destination information via the communication section 52 (S181). Then, the control section 51 transmits the thus received enciphered authentication information, terminal ID, and service destination information from the transmitting section 53 to the broadcasting network (S182).

A control section 11 of the portable telephone 10a receives the enciphered authentication information, terminal ID, and service destination information transmitted from the broadcasting base station 50 (S191). Then, the control section 11 judges whether or not the terminal ID thus received via the terminal ID judging section 11a is its own terminal ID (S192).

If the control section 11 judges that the thus received terminal ID is its own terminal ID, the control section 11 causes a cipher storage section 15 to store therein the thus received enciphered authentication information, terminal ID, and service destination information (S193). Then, the process is completed.

On the other hand, if the control section 11 judges that the thus received terminal ID is not its own terminal ID, the control section 11 destroys the thus received enciphered authentication information, terminal ID, and service destination information (S194). Then, the process is completed.

After that, in case where the portable telephone 10a requests the server 20a to provide a service, a process similar to that of the service providing system 1 illustrated in FIG. 4 is performed, except that the service providing system 1a is arranged such that service request information to be transmitted from the portable telephone 10a to the server 20a contains the terminal ID.

As described above, the service providing system 1a according to the present embodiment is arranged such that (a) the enciphered authentication information, which is created from the authentication information authorized for the service by the server 20a, and (b) the terminal ID and service destination information of the portable telephone 10a which is authorized to receive the service are transmitted via the broadcasting network (the service destination information regards destination to which the portable telephone 10a requests to provide a service).

After receiving the enciphered authentication information, terminal ID, and service destination information, the portable telephone 10a judges whether or not the thus received terminal ID is its own terminal ID. If the thus received terminal ID is its own terminal ID, the portable telephone 10a causes the cipher storage section 15 to store therein the enciphered authentication information and the service destination information thus received together with the terminal ID.

With this arrangement, the user of the portable telephone 10a dose not need to input the authentication information (user ID and password) when he requests the server 20a to provide the service. That is, the user can receive the service from the service 20a by using the portable telephone 10a without inputting the authentication information at all. This allows the service to be provided more user friendlily.

The present invention is not limited to the arrangement explained above, in which the enciphered authentication information, terminal ID, and service destination information are transmitted to the portable telephone 10a from the server 20a via the broadcasting network. For example, the transmission may be carried out via the Internet or the like. In this case, the transmission from the server 20a to the portable telephone 10a may be carried out by transmitting, to an address of the portable telephone 10a, the data that does not includes the terminal ID. Moreover, instead of performing the process of judging whether or not the thus received terminal ID is its own terminal ID, and the portable telephone 10a may store all the enciphered authentication information and service destination information thus received.

Moreover, the present invention is not limited to the arrangement in which at S171 the authentication information (user ID, password, terminal ID), which is authorized to receive the service, is transmitted via the authentication information input section 29. For example, instead of the process of S171, the user of the portable telephone 10a may perform first-time authentication by using another service using device (another terminal telephone, a personal computer, or the like), and designate the terminal ID of the portable telephone 10a. This first-time authentication process may be performed in a similar manner to the first-time authentication process illustrated in FIG. 3 for the first embodiment. In an alternative, the present invention is applicable to a case where a user who has been using the service by using another service using device (i.e. who has signed on for the service) designates the terminal ID of the portable telephone 10a in order to use the service by using the portable telephone 10a.

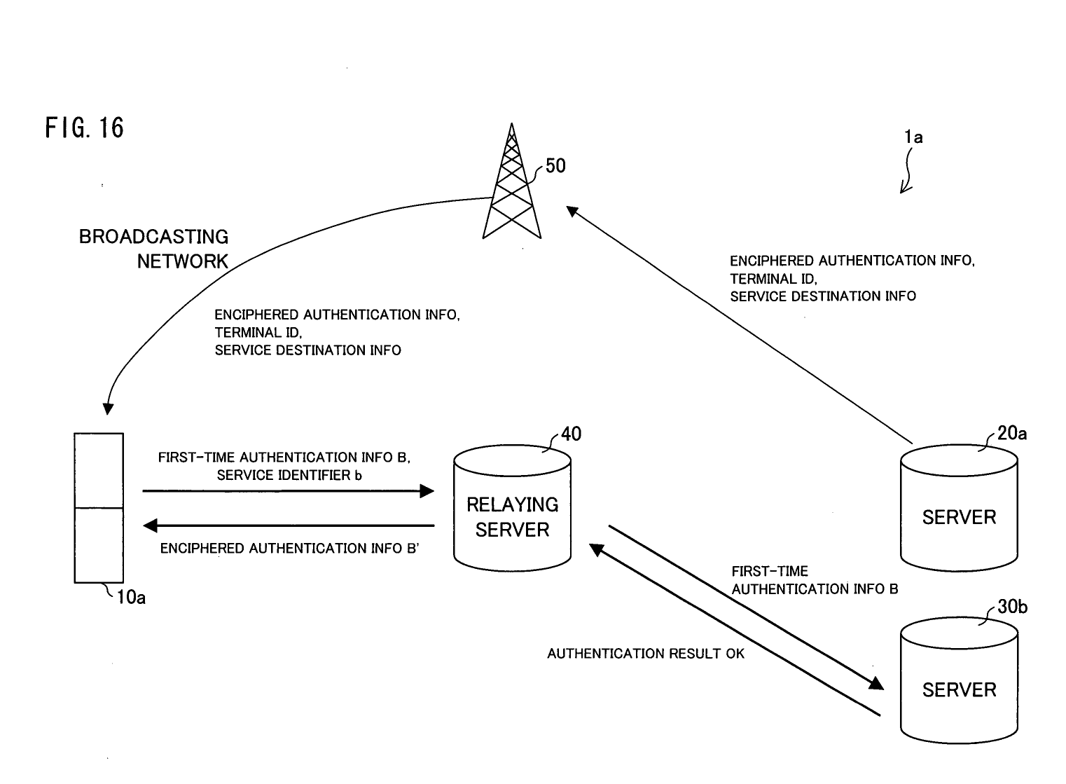

Moreover, even though the present embodiment is arranged such that when the user of the portable telephone 10a requests for the service the enciphered authentication information, terminal ID, and the service requesting information are transmitted from the portable telephone 10a to the server 20a, the present invention is not limited to this arrangement. For example, when the user of the portable telephone 10a requests for the service, the enciphered authentication information, the terminal ID, service request information (or service identifier) are transmitted from the portable telephone 10a to the server 20a via a relay server 40 illustrated in FIGS. 5(a) and 5(b). That is, as illustrated in FIG. 16, the service providing system 2a illustrated in FIG. 9(a) may be provided with the server 20a in lieu of the server 30a, and with the portable telephone 10a in lieu of the portable telephone 10.

In the amendment illustrated in FIG. 16, first-time authentication for a service whose enciphered authentication information is not stored in the portable telephone 10a can be carried out by performing processes similar to those illustrated in FIG. 10. That is, for the first-time authentication, the user of the portable telephone 10a is only required to input the authentication information with respect to the service whose enciphered authentication information is not stored in the portable telephone 10a.

Moreover, in the arrangement illustrated in FIG. 16, the service whose enciphered authentication information is stored in the portable telephone 10a can be provided simply by performing processes similar to those illustrated in FIG. 11. That is, in order to use the service provided from the server 20a, the portable telephone 10a performs the processes similar to those illustrated in FIG. 10. Because, in order to receive, by using the portable telephone 10a, the service whose enciphered authentication information is provided via the broadcasting network, the user does not need to input the authentication information by himself in using the service, it is easy for the user to the service, even if the he is using plural services concurrently.

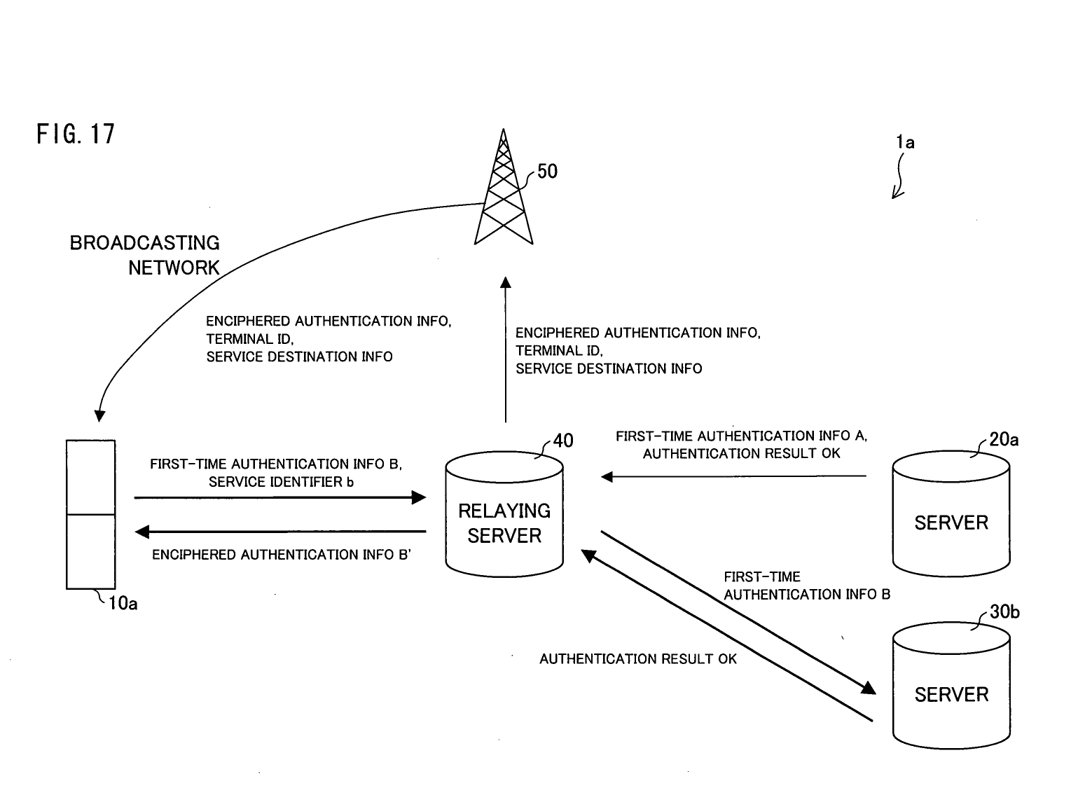

Moreover, the enciphering process of the authentication information may be performed by the relaying server 40, but not by the server 20a. FIG. 17 is an explanatory view illustrating first-time authentication process of a service providing system 1a thus arranged.

As illustrated in FIG. 17, authentication information (user ID, password, terminal ID) which is authorized to receive the service is inputted via the authentication information input section 29 of the server 20a. Then, the server control section 21 sends, to the relaying server 40, the thus inputted authentication information, the thus inputted terminal ID, the service destination information (or service identifier), and an authentication result that informs successful authentication (i.e. the user is authenticated to be provided with a service). A relaying server control section 41 of the relaying server 40 causes the enciphering section 43 to encipher the thus received authentication information, and causes a communication section 42 to transmit the enciphered authentication information, terminal ID, service destination information (or service identifier) to the broadcasting base station 50 via the Internet or the like. Then, the broadcasting base station 50 transmits, via the broadcasting network, the thus received enciphered authentication information, terminal ID, service destination information (or service identifier). The relaying server control section 41 of the relaying server 40 may be arranged to transmit the enciphered authentication information, terminal ID, and service destination information (or service identifier) directly to the portable telephone 10a via the Internet or the like from the communication section 42, instead of transmitting the enciphered authentication information, terminal ID, and service destination information (or service identifier) to the portable telephone 10a via the broadcasting network.

Again in this arrangement, the user does not need to input the authentication information by himself in order to be provided with the service by using the portable telephone 10a. Therefore, it is easy for the user to the service, even if the he is using plural services concurrently.

### Fifth Embodiment

Yet still another embodiment of the present invention is described below. For the sake of easy explanation, members having the same function as the members described in the first to fourth embodiments are labeled in the same manner and their explanation is omitted here.

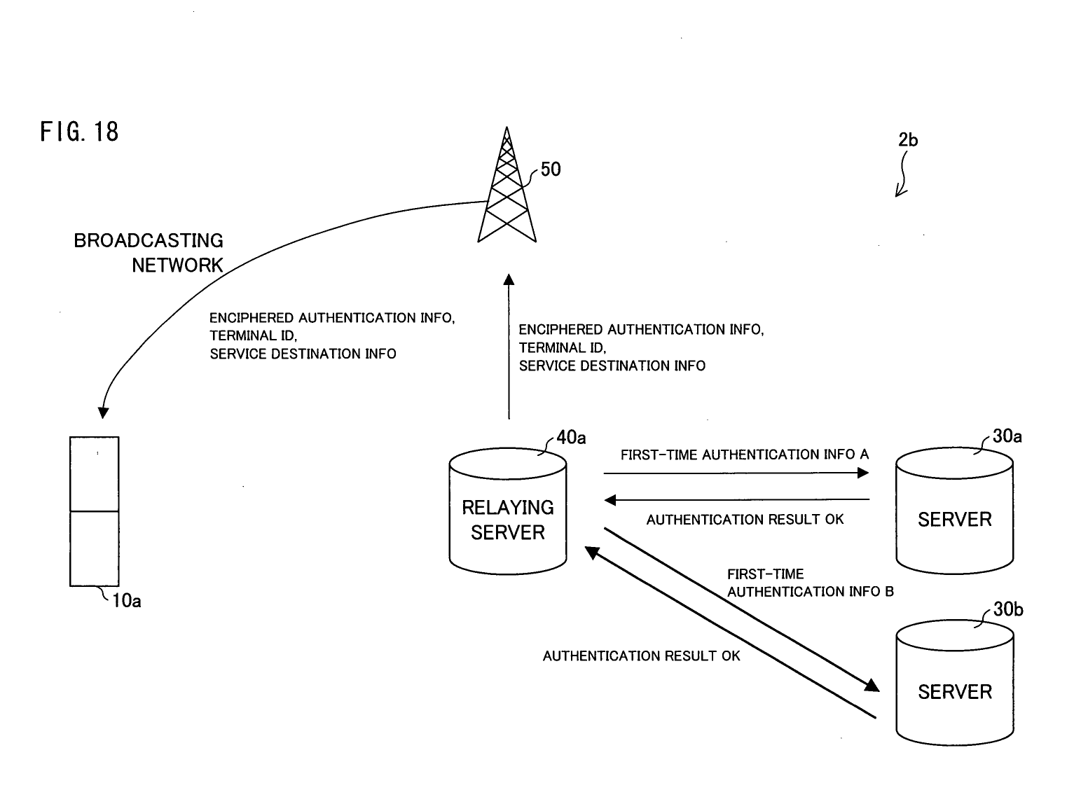

FIG. 18 is an explanatory view schematically illustrating a service providing system 2b according to the present embodiment. As illustrated in FIG. 18, the service providing system 2b is provided with a portable telephone (information terminal device, service using device) 10a, servers (service providing devices) 30a and 30b, and a relaying server 40a, which are connected with each other via a network such as the Internet or the like so that they can communicate with each other. Moreover, the server providing system 2b is arranged such that (a) enciphered authentication information of a user authorized to receive a service, (b) terminal ID, and (c) service destination information are transmitted from the relaying server 40a to the broadcasting base station 50 via the Internet or the like, and then transmitted via a broadcasting network from the broadcasting base station 50.

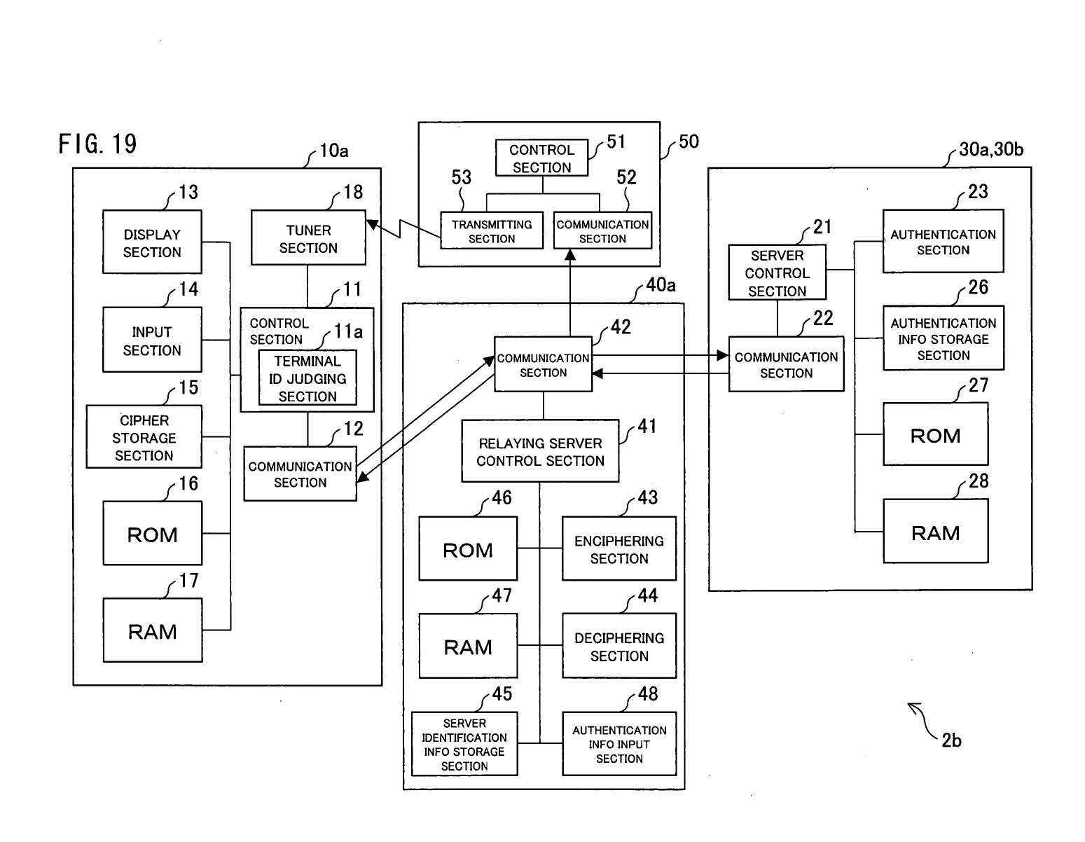

FIG. 19 is a block diagram schematically illustrating the portable telephone 10a, relaying server 40a, servers 30a and 30b, and broadcasting base station 50. As illustrated in FIG. 19, the relaying server 40a, which has the same arrangement as the relaying server 40 illustrated in FIG. 6, is further provided with an authentication information input section 48.

The authentication information input section 48 receives an input of (a) a user ID of a user for whom first-time authentication process is to be performed, (b) password, and (c) a terminal ID of the portable telephone 10a to which the service is to be provided. The authentication information input section 48 is not particularly limited in terms of its arrangement, and may be any kind of input means such as a keyboard, mouse pointer, jog dial, pen input device, touch panel, voice input device, or the like. The input means may be provided to the portable telephone 10a or connected to the portable telephone 10a wirelessly or via a cable.

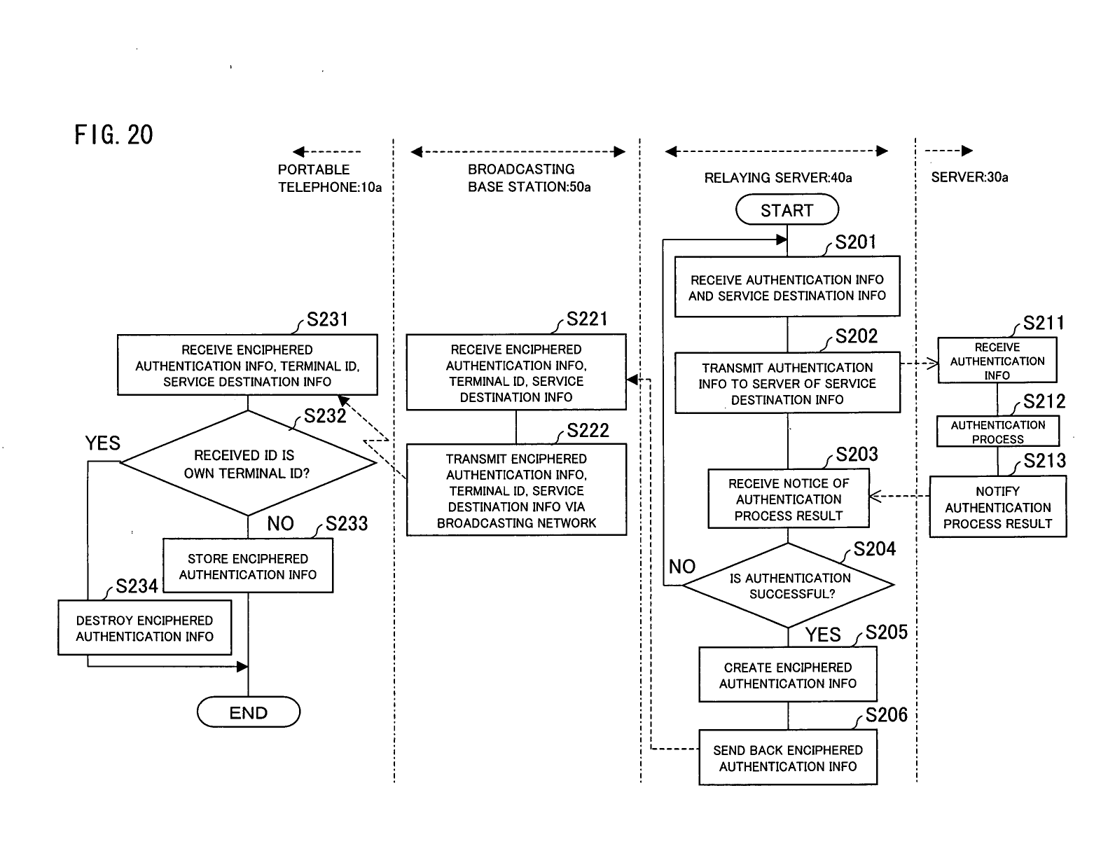

Next, operations in the first-time authentication in the service providing system 2b are explained below. FIG. 20 is a flow chart illustrating a flow of the first-time authentication process of the service providing system 2b.

A relaying server control section 41 of the relaying server 40a receives an input of first-time authentication information (user ID, password, terminal ID) and service destination information inputted via the authentication information input section 48 (S201).

Next, to the server (here, server 30a) specified by the service destination information, the relaying server control section 41 transmits the first-time authentication information inputted at S211 (S202). Moreover, the relaying server control section 41 causes a RAM 47 to store therein this authentication information and service destination information.

A server control section 31 of the server 30a receives the authentication information transmitted from the server relaying server 40a (S211). Then, the serer control section 31 causes an authentication section 23 to perform the authentication process for the thus received authentication information (S212). After that, the server control section 31 transmits an authentication result to the relaying server 40a via the communication section 22 (S213).

The relaying server control section 41 of the relaying server 40a receives the notice of the authentication result from the server 30a (S203). Then, the relaying server control section 41 of the relaying server 40a judges whether or not the authentication is successful in the server 30a (S204). If the relaying server control section 41 judges that the authentication is not successful, the relaying server control section 41 waits for another input of the first-time authentication information and the service destination information. The relaying server 40a may be provided with displaying means or voice output means so that the failure of the authentication can be notified of a person who inputs the first-time authentication information via the authentication information input section 48.

On the other hand, if at S204 the relaying server control section 41 judges that the authentication is successful, the relaying server control section 41 reads but the first-time authentication information from the RAM 47 where they are stored, and then causes an enciphering section 43 to encipher the user ID and password contained in the first-time authentication information, thereby to create enciphered authentication information (S205).

Next, the relaying section 41 transmits, the enciphered authentication information thus created at S205, the terminal ID, and the service destination information to the broadcasting base station via a communication section 42 (S206).

A control section 51 of the broadcasting base station 50 receives the enciphered authentication information, the terminal ID, and the service destination information via a communication section 52 (S221). Then, the control section 51 transmits the thus received enciphered authentication information, terminal ID, service destination information from a transmitting section 53 to a broadcasting network (S222).

A control section 11 of the portable telephone 10a receives the enciphered authentication information, terminal ID, service destination information from the broadcasting base station 50 (S231). Then, the control section 11 causes a terminal ID judging section 11a to judge whether or not the thus received terminal ID is its own terminal ID (S232).

If it is judged that the thus received terminal ID is its own terminal ID, the control section 11 causes a cipher storage section 15 to store the thus received enciphered authentication information, terminal ID, service destination information (S233). Then, the process is terminated.

If it is judged that the thus received terminal ID is not its own terminal ID, the control section 11 destroys the thus received enciphered authentication information, terminal ID, service destination information (S234). Then, the process is terminated.

After that, to request, by using use the portable telephone 10a, the server 30a to provide the service, processes similar to those of the service providing system 2 illustrated in FIG. 8 or processes similar to those of the service providing system 2a illustrated in FIG. 11 are performed, except that in the service providing system 2b service request information to be transmitted from the portable telephone 10a to the server 30a includes the terminal ID.

As described above, the service providing system 2b according to the present embodiment is arranged such that the relaying server 40a is provided with the authentication information input section 48 for receiving the input of the first-time authentication information. The relaying server 40a receives the first-time authentication information of a given service via the authentication information input section 48 and then transmits the first-time authentication information to the serve 30a that provides the given service. If the relaying server 40a receives the authentication result that informs the success of the first-time authentication, the relaying server 40a causes the enciphering section 43 to encipher the first-time authentication information (user ID, password), thereby to create the enciphered authentication information. Then, the relaying server 40a transmits the thus enciphered authentication information to the broadcasting base station 50. The broadcasting base station 50 then transmits the enciphered authentication information to the portable telephone 10a via the broadcasting network.

With this arrangement, the user of the portable telephone 10a does not need to input the authentication information (user ID and password) via the portable 10a, for requesting the server 30a to provide the service. That is, to be provided with the service from the server 20a via the portable telephone 10a, the user does not need to input the authentication information even once. This makes it more convenient for the user to use the service.

The present invention is not limited to the arrangement described above in which the relaying server 40a uses the broadcasting network to transmit the enciphered authentication information, terminal ID, and service destination information to the portable telephone 10a. For example, the Internet or the like may be used to transmit such information. In this case, the replaying server 40a may transmit data to an address of the portable telephone 10a, the data not including the terminal ID. In this case, the portable telephone 10a may be arranged such that the step of judging whether or not the terminal ID thereof is contained or not in the received data is omitted and all the thus receive enciphered authentication information and service destination information are stored therein.

Moreover, the present invention is not limited to the process of S201 in which the authentication information (user ID, password, terminal ID) which is authorized to receive the service, and service destination information are inputted. For example, in lieu of the process of S201, the present invention may be arranged such that the user of the portable telephone 10a carries out the first-authentication by using another service using device (another portable telephone, a computer or the like) in a similar manner to that of the arrangement illustrated in FIG. 7 or 11, and designates the terminal ID of the portable telephone 10a. In another alternative, the present invention is applicable to a case where a user who has been using the service by using another service using device (i.e. who has signed on for the service) designates the terminal ID of the portable telephone 10a in order to use the service by using the portable telephone 10a.

The control section 11 of the portable telephone 10 or 10a, the server control section 21 of the server 20, 20a, 30, 30a, or 30b, the relaying server control section 41 of the relaying server 40 or 40a, the enciphering section 24 and deciphering section 25 of the server 20 or 20a, and the enciphering section 43 and deciphering section 44 of the relaying server 40 or 40a, which are described in the respective embodiments, are functional blocks that are realized as a result of execution of a program code(s) by computing means such as CPU or the like, the program code(s) being stored in a recording medium(s) such as ROM, RAM or the like. Therefore, an object of the present invention can be attained by supplying a recording medium to a system or a device, and causing a computer (or CPU) provided in the system or the device to read and execute a program code (executing program, intermediate code program, source program) of a program stored in the recording medium. The program stored in the recording medium is software for realizing a function of each section described above.

On the other hand, these sections may be realized by hardware that performs similar processes to these of the software. In this case, the object of the present invention can be achieved by using the control section 11 of the portable telephone 10 or 10a, the server control section 21 of the server 20, 20a, 30, 30a, or 30b, the relaying server control section 41 of the relaying server 40 or 40a, the enciphering section 24 and deciphering section 25 of the server 20 or 20a, the enciphering section 43 and deciphering section 44 of the relaying server 40 or 40a, and/or the like, which are hardware. Moreover, these sections can be realized by a combination of (a) hardware that performs part of the processes and (b) computing means for executing a program code for controlling the hardware and for performing the rest of the processes other than that part of the processes which hardware does. Of these sections, some sections are explained as hardware. The sections that are explained as hardware can be also realized by a combination of (a) hardware that performs part of processes and (b) computing means for executing a program code for controlling the hardware and for performing the rest of the processes other than that part of the processes which hardware does.

The computing means may be a sole computing means, or a plurality of computing means connected via a bus or a communication route of any kind which is provided inside a device. Here, the plurality of computing means execute the program code in cooperation.

Therefore, the control section 11 of the portable telephone 10 or 10a, the server control section 21 of the server 20, 20a, 30, 30a, or 30b, the relaying server control section 41 of the relaying server 40 or 40a, the enciphering section 24 and deciphering section 25 of the server 20 or 20a, the enciphering section 43 and deciphering section 44 of the relaying server 40 or 40a, according to the present invention can be provided anywhere within the service providing system.

Moreover, the program may be a program code itself, which can be executed by the computing means directly, or data from which the program code can be created by a process such as later-described decomposition or the like. The program (the program or the data) may be stored in recording medium which is then distributed. In an alternative, the program (the program or the data) may be distributed e.g., by being transmitted by communication means that is for transmission via a communication route that is wire or wireless route. After distributed in such a way, the thus distributed program (the program or the data) is executed by the computing means.

In case the program is transmitted via the communication route, the program is transmitted via the communication route by transmitting a series of signals via a transmission medium/media of various kinds that constitute the communication route, the series of signals representing the program. Moreover, the transmission of the series of signals may be arranged such that a transmission device modulates a carrier wave by the series of signals that represents the program. This causes the series of signals to overlap on the carrier wave. In this case, the series of signals is restored by demodulating the carrier wave by a receiving device. On the other hand, the transmission of the series of signals may be arranged such that the series of signals as a series of digital data is divided into packets by the transmission device. In this case, the receiving device restores the series of signals by connecting packets it receives. Moreover, the transmission of the series of signals by the transmitting device may be carried out by multiplex transmission together with another series of signals, e.g., by time division multiplexing, frequency division multiplexing, code division multiplexing, or the like method. In this case, the receiving device extracts the series of signals out of the multiplexed series of signals, and restores the series of signals. The either arrangements are similarly effective as long as the program can be transmitted via the communication route.

Here, the recording medium for use in the distribution of the program is preferably detachable. However, the recording medium after the distribution of the program is done may or may not be detachable. Moreover, the recording medium may or may not be rewritable (writable), or may or may not be volatile, as long as the program is stored in the recording medium. Furthermore, the program (the program or the data) may be stored in any method or in any format. Examples of the recording medium/media are: tapes such as magnetic tapes, cassette tapes, and the like; magnetic discs such as floppy (registered trademark) discs, hard discs, and the like; discs such as CD-ROM, magneto-optical discs (MO), mini discs (MD), digital video disk (DVD), and the like; and the like. Moreover, the recording medium/media may be a card such as an IC card, optical card, or the like, or may be a semiconductor memory such as a mask ROM, EPROM, EEPROM, flash ROM, or the like. In an alternative, the recording medium/media may be a memory provided in computing means such as CPU or the like.

The program code may be a code that instructs the computing means as to all the processes of each section. In an alternative, if there has been provided a basic program (e.g., an operation system, library, or the like) that can perform part or whole of the processes of each section by being read out in a predetermined procedure, the part or whole of the processes of each section may be replaced by a code, a pointer or the like for instructing the computing device to read out the basic program.

Moreover, as to how to store the program(s) in the recording medium/media, the program(s) may be stored in the recording medium/media in a recording format that is accessible and executable by the computing means. For example, the program(s) may be stored in the recording medium/media in a recording format for a program loaded in a real memory. In an alternative, the program(s) may be stored in the recording medium/media in a recording format for a program which, before being loaded into the real memory, is installed in a local recording medium (e.g., a real memory, hard disc, etc.) that is always accessible by the computing means. In another alternative, the program(s) may be stored in the recording medium/media in a recording format for a program which is to be installed in such local recording medium from a network, a distributable recording medium, or the like.

The program(s) is/are not limited to an object code that has been compiled: The program may be stored in the recording medium/media, as a source code, or an intermediate code that is created in process of interpretation or compiling. Either arrangements are similarly effective regardless of the format of the program(s) stored in the recording medium/media as long as the intermediate code can be converted into a format that the computing means can execute. The conversion of the intermediate code may be carried out by, for example, decompression of compressed information, restoration of coded information, interpretation, compiling, linking, loading into a real memory, or the like process, or a combination of any of these processes.

Even thought each embodiment discusses the case where the service using device is the portable telephone 10, the present invention is not limited to this. For example, the service using device may be a PHS (Personal Handyphone System (Registered Trademark), a PDA (Personal Digital Assistance), a personal computer, a word processor, a television broadcast transmitting/receiving machine, or the like, beside the portable phone.

A first service providing system of the present invention includes a service using device, and service providing devices each of which provides a given service in accordance with a request from the service using device to which the service providing device is connected via a network. In order to attain the object, the first service providing system is arranged as follows: the service using device includes (a) an input section for receiving an instruction from a user, the instruction specifying a requested service, (b) a cipher storage section for storing therein enciphered authentication information, and (c) a using device control section that transmits enciphered authentication information that corresponds to the requested service, to that service providing device which provides the requested service; and each of the service providing devices includes (A) an authentication information storage section for storing therein authentication information of a user authenticated for a service, (B) an authentication section for performing authentication process for matching authentication information of the user requesting for the service, against the authentication information of the user authorized to receive the service, a deciphering section for deciphering enciphered authentication information so as to create deciphered authentication information, and (C) a providing device control section wherein if the providing device control section receives the enciphered authentication information from the service using device, the providing device control section causes the deciphering section to decipher the thus received enciphered authentication information so as to create deciphered authentication information, and causes the authentication section to perform the authentication process of the thus created deciphered authentication information.

To request for a service, the using device control section transmits the enciphered authentication information to the service providing device in this arrangement. Then, the service providing device deciphers the thus received enciphered authentication information, and performs authentication process for the deciphered authentication information. With this arrangement, unlike the conventional art, the user does not need to input the authentication information every time, the authentication information regarding the requested service. This arrangement, therefore, improve the authentication process to be more user friendly.

Moreover, in this arrangement, the service using device stores the enciphered authentication information. Because of this, the authentication information regarding the service is protected from being stolen, for example, even if a recording region of the service using device is analyzed. Therefore, it is possible to improve security (safety) of the authentication information.

The service providing system may be arranged such that the using device control section judges whether or not enciphered authentication information corresponding to the requested service is stored in the cipher storage section, and if the enciphered authentication information corresponding to the requested service is not stored, the using device control section transmits, as first-time authentication information, authentication information to that service providing device which provides the requested service, the authentication information regarding the requested service and being provided from a user via the input section, each of the service providing devices comprises: an enciphering section for enciphering the authentication information so as to create the enciphered authentication information, and if the providing device control section receives the first-time authentication information from the service using device, the providing device control section causes the authentication section to perform the authentication process of the first-time authentication information, and if the authentication of the first-time authentication information is successful, the providing device control section causes the enciphering section to encipher the first-time authentication information so as to create enciphered authentication information and transmits the thus created enciphered authentication information to the service using device that has transmitted the first-time authentication information thereto. In case where the enciphered authentication information corresponding to the requested service is stored in the ciphering storage section, the using device control section transmits the enciphered authentication information to the service providing device in this arrangement.

On the other hand, in case where the enciphered authentication information corresponding to the requested service is not stored in the ciphering storage section, the using device control section transmits, to the service providing device, the authentication information regarding the service requested via the input section by the user.

With this arrangement, the user need input the authentication information only in case the enciphered authentication information corresponding to the requested service is not stored in the ciphering storage section, that is, in case where the authentication process for the authentication information regarding the service has not been completed yet. Therefore, the user does not need to input the authentication information in the non-first-time authentication process. Thus, the user does not nee to input the authentication information for the service every time unlike the conventional art. This improves the authentication process to be more user friendly.

Moreover, in the above arrangement, if the authentication process for the first-time authentication information is successful, the authentication information is enciphered. Then, the enciphered authentication information is stored in the service using device. That is, the service using device stores therein the enciphered authentication information. Because of this, the authentication information regarding the service is protected from being stolen, for example, even if a recording region of the service using device is analyzed. Therefore, it is possible to improve the authentication information in terms of security (safety).

Moreover, the service providing system may be arranged such that each of the service providing devices includes: an authentication information input section for receiving an input of authentication information of a user who is authorized to receive the service; and an enciphering section for enciphering the authentication information so as to create the enciphered authentication information, and the providing device control section causes the enciphering section to encipher the authentication information thus inputted into the authentication information input section so as to create the enciphered authentication information and transmits the thus created enciphered authentication information to the service using device.

In this arrangement, the service providing device receives the input of the authentication information of the user who is authorized to receive the service, and enciphers the authentication information. Then, the service providing device transmits the thus enciphered authentication information to the service using device. With this arrangement, the user of the service using device does not need to input the authentication information. Therefore, the authentication process can be more user friendly.

The providing device control section may transmit the enciphered authentication information to the service using device via a broadcasting network.

In this case, the service providing system may be further arranged such that the authentication information input section receives a terminal ID that identifies that service using device which is authorized to receive the service, the providing device control section transmits the enciphered authentication information and the terminal ID to the service using device. In case where the transmission of the enciphered authentication information is carried out via the broadcasting network, the service using device receives, in some cases, the enciphered authentication information that is directed to another service using device. The arrangement in which the terminal ID is transmitted in addition to the enciphered authentication information allows the service providing device to judge whether the enciphered authentication information is enciphered authentication information that is directed thereto.

A second service providing system of the present invention includes a service using device, a service relay device, and service providing devices, the service relay device connecting, via a network, the service using device with that service providing device which provides a service that the service using device requests, and the service providing device or service providing devices being connected to the service relaying device via the network. In order to attain the object, the second service providing system is arranged as follows: the service using device includes (a) an input section for receiving an instruction from a user, the instruction specifying a requested service, (b) a cipher storage section for storing therein received enciphered authentication information, and (c) a using device control section that transmits the enciphered authentication information corresponding to the requested service, to the service relaying device; each of the service providing devices includes (A) an authentication information storage section for storing therein authentication information of a user authenticated for a service, and (B) an authentication section for performing authentication process for matching authentication information of the user requesting for the service, against the authentication information of the user authorized to receive the service; and the service relaying device includes (i) a deciphering section for deciphering enciphered authentication information so as to create deciphered authentication information, and (ii) a relaying control section, wherein if the relaying control section receives the enciphered authentication information from the service using device, the providing device control section causes the deciphering section to decipher the thus received enciphered authentication information so as to create deciphered authentication information, and transmits the thus created deciphered authentication information to that service providing device which provides a service that is requested by the service using device having transmitted the enciphered authentication information to the relaying control section.

To request for a service, the using device control section transmits the enciphered authentication information to the service relaying device in this arrangement. Then, the service relaying device deciphers the thus received enciphered authentication information thereby to create deciphered authentication information. The service relaying device transmits the deciphered authentication information to the service providing device. The service providing device performs the authentication process for the deciphered authentication information thus received from the service relaying device. With this arrangement, unlike the conventional art, the user does not need to input the authentication information every time, the authentication information regarding the requested service. This arrangement, therefore, improve the authentication process to be more user friendly.

Moreover, in this arrangement, the service using device stores the enciphered authentication information. Because of this, the authentication information regarding the service is protected from being stolen, for example, even if a recording region of the service using device is analyzed. Therefore, it is possible to improve security (safety) of the authentication information.

The service providing system may be arranged such that the service providing device comprises a providing control section that transmits, to the service relaying device, authentication result information that informs a result of the authentication process, and the using device control section judges whether or not enciphered authentication information corresponding to the requested service is stored in the cipher storage section, and if the enciphered authentication information corresponding to the requested service is not stored, the using device control section transmits, as first-time authentication information, authentication information to the service relaying device, the authentication information regarding the requested service and being provided from a user via the input section; and the service relaying device includes an enciphering section for enciphering the authentication information so as to create the enciphered authentication information; if the relaying control section receives the first-time authentication information from the service using device, the relaying control section transmits the thus received first-time authentication information to that service providing device which provides a service that is requested by the service using device having transmitted the first-time authentication information to the relaying control section, and if the relaying control section receives, from the service providing device, an authentication process result that informs success of the authentication process of the first-time authentication information, the relaying control section causes the enciphering section to encipher the first-time authentication information so as to create enciphered authentication information, and transmits the thus created enciphered authentication information back to the service using device that has transmitted the first-time authentication information.

In case where the enciphered authentication information corresponding to the requested service is stored in the ciphering storage section, the using device control section transmits the enciphered authentication information to the service relaying device in this arrangement. On the other hand, in case where the enciphered authentication information corresponding to the requested service is not stored in the ciphering storage section, the using device control section transmits, to the service relaying device, the authentication information regarding the service requested via the input section by the user.

With this arrangement, the user need input the authentication information only in case the enciphered authentication information corresponding to the requested service is not stored in the ciphering storage section, that is, in case where the authentication process for the authentication information regarding the service has not been completed yet. Therefore, the user does not need to input the authentication information in the non-first-time authentication process. Thus, the user does not nee to input the authentication information for the service every time unlike the conventional art. This improves the authentication process to be more user friendly.

Moreover, in the above arrangement, if the authentication process for the first-time authentication information is successful, the authentication information is enciphered. Then, the enciphered authentication information is stored in the service using device. That is, the service using device stores therein the enciphered authentication information. Because of this, the authentication information regarding the service is protected from being stolen, for example, even if a recording region of the service using device is analyzed. Therefore, it is possible to improve the authentication information in terms of security (safety).

Moreover, this arrangement allows the service using device to be arranged as such, by providing the service relaying device with the enciphering section and deciphering section. This makes it possible to use a service providing device used in a conventional service providing system. Therefore, the existing service providing device can be utilized in the this arrangement.

Moreover, in addition to this arrangement, the service providing system may be arranged such that in case where the using device control section requests for plural services, the using device control section transmits, to the service relaying device, a batch of respective pieces of the first time authentication information of the requested services, the relaying control section (a) selects, from among the service providing devices connected to the relaying control section via the network, those service providing devices which provide services that correspond to the respective pieces of the first-time authentication information, and (b) transmits the respective pieces of the first-time authentication information thus received from the service using device, respectively to the thus selected service providing devices, and if the relaying control section receives, from any one of the service providing devices, an authentication process result that informs success of the authentication process of the first-time authentication information, the relaying control section causes the enciphering section to encipher the first-time authentication information so as to create enciphered authentication information, and transmits the thus created enciphered authentication information back to the service using device that has transmitted the first-time authentication information.

With this arrangement, the user is allowed to input a batch of the pieces of authentication information for the services in case he wants to use plural services. As a result, by performing the input of authentication information once, he can receive the plural services he desires. This improves the first-time authentication of the services to be more user friendly.

Moreover, the service providing system may be arranged such that in case where the using device control section requests for plural services, the using device control section (a) judges whether or not respective pieces of enciphered authentication information of the requested services are stored in the ciphering storage section, (b) receives, from the user, input of authentication information of that service which is not stored in the cipher storage section, and (c) transmits the thus received authentication information to the service relay device as first-time authentication information, the relaying control section (d) selects, from among the service providing devices connected the service relay device via the network, those service providing devices which provide services that correspond to the respective pieces of the first-time authentication information, and (e) transmits the respective pieces of the first-time authentication information thus received from the service using device, respectively to the thus selected service providing devices, and if the relaying control section receives an authentication process result from any one of the service providing devices, the relaying control section causes the enciphering section to encipher the first-time authentication information so as to create enciphered authentication information, and transmits the thus created enciphered authentication information back to the service using device that has transmitted the first-time authentication information.

With this arrangement, in case he wants to use plural services, the user need input only the authentication information for the service, the authentication of which has not been completed yet (i.e., the service whose enciphered authentication information is not stored). Therefore, the input of the authentication information becomes more user friendly.

The service providing system may be arranged such that each of the service providing devices comprises an authentication information input section for receiving an input of authentication information of a user who is authorized to receive the service; the providing device control section transmits, to the service relaying device, the authentication information thus inputted via the authentication information input section; the relaying control section comprises an enciphering section for enciphering authentication information so as to create enciphered authentication information; and if the relaying control section receives the authentication information from the service providing device, the relaying control section causes the enciphering section to encipher the authentication information so as to create enciphered authentication information, and transmits the thus created enciphered authentication information to the service using device.

In this arrangement, the service providing device receives the input of the authentication of the user who is authorized to receive the service. The thus inputted authentication information (authentication information of the user authorized to receive the service) is transmitted to the service relaying device. Then, the service relaying device receives and enciphers the authentication information. The thus enciphered authentication information is transmitted to the service using device. In this arrangement, the user of the service using device does not need to input the authentication information. Therefore, the authentication process becomes more user friendly.

The service providing system may be arranged such that the service relaying device includes an authentication information input section for receiving an input of authentication information and information that specifies that service providing device which performs authentication process by using that authentication information; and an enciphering section for enciphering authentication information so as to create enciphered authentication information, and that the relaying control section transmits the authentication information thus inputted via the authentication information input section to that service providing device which performs the authentication process by using that authentication information, and if the relaying control section receives, from that service providing device, an authentication process result that informs success of the authentication process, the relaying control section causes the enciphering section to encipher that authentication information for which the authentication is successful, so as to create enciphered authentication information, and then transmits the thus created enciphered authentication information to the service using device.

In this arrangement, the service relaying device receives the authentication information and the information that specifies that service providing device which performs the authentication process by using the authentication information. Then, the service relaying device transmits the authentication information to the service providing device. If the service relaying device receives the authentication process result that informs that the authentication is successful, the service relaying device enciphers the authentication information and transmits the thus enciphered authentication information to the service using device. As a result, the user does not need to input the authentication information. Therefore, the authentication process becomes more user friendly.

The service providing system may be arranged such that the relaying control section transmits the enciphered authentication information to the service using device via a broadcasting network. In this case, the authentication information input section may be arranged to receive a terminal ID that identifies that service using device which is authorized to receive the service; and the providing device control section may be arranged to transmit the enciphered authentication information and the terminal ID to the service using device.

The service providing system may be arranged such that in case where the using device control section requests for plural services, the using device control section (a) judges whether or not respective pieces of enciphered authentication information of the requested services are stored in the ciphering storage section, (b) if all the pieces of enciphered authentication information of the requested service are stored, transmits all the pieces of enciphered authentication information to the service relay device, the relaying control section (c) causes the deciphering section to decipher the respective pieces of enciphered authentication information thus received from the service using device, so as to create respective pieces of deciphered authentication information, (d) selects, from among the service providing devices connected the service relay device via the network, those service providing devices which provide services that correspond to the respective pieces of the deciphered authentication information, and (e) transmits the respective pieces of deciphered authentication information, respectively to the thus selected service providing devices, and the relaying control section receives service contents respectively from the service providing devices and transmits back to a batch of the thus received service contents to the service using device.

In this arrangement, in case the user requests for plural services, a batch of the service contents provided from the respective service providing devices is transmitted to the service using device. With this arrangement, the services provided respectively from the plural service providing devices can be used concurrently or in combination by the user.

A service using device of the present invention for receiving a service from a service providing device, includes: an input section for receiving an instruction from a user, the instruction specifying a requested service; a cipher storage section for storing therein thus received enciphered authentication information; and a using device control section that transmits enciphered authentication information that corresponds to the requested service, to that service providing device which provides the requested service.

This arrangement allows the user to request for the service, simply by inputting the instruction to specify the service he requests: the user is not required to input the authentication information in order to request for the service. Moreover, in this arrangement, the service using device stores the enciphered authentication information therein. Because of this, the authentication information regarding the service is protected from being stolen, for example, even if a recording region of the service using device is analyzed. Therefore, it is possible to improve the authentication information in terms of security (safety).

The service using device may be arranged such that the using device control section judges whether or not enciphered authentication information corresponding to the requested service is stored in the cipher storage section, and if the enciphered authentication information corresponding to the requested service is not stored, the using device control section transmits, as first-time authentication information, authentication information to that service providing device which provides the requested service, the authentication information regarding the requested service and being provided from a user via the input section.

In this arrangement, if the enciphered authentication information corresponding to the requested service is stored in the cipher storage section, the using device control section transmits the enciphered authentication information to the service providing device. If the enciphered authentication information corresponding to the requested service is not stored in the cipher storage section, the using device control section transmits, to the service providing device, the authentication information regarding the service that user requests via the input section.

Therefore, the user is required to input the authentication information only for the first-time authentication process, and does not need to input the authentication information at the non-first-time authentication process. This improves the authentication process to be more user friendly.

The service using device may be arranged such that it includes a receiving section for receiving enciphered authentication information and a terminal ID transmitted via a broadcasting network; and a terminal ID judging section for judging whether or not the thus received terminal ID is an own terminal ID of the service using device, and if the thus received terminal ID is the own terminal ID of the service using device, the using device control section causing the cipher storage section to store therein the thus received enciphered authentication information together with the terminal ID.

With this arrangement, enciphered authentication information transmitted especially for the service using device can be selected from among pieces of enciphered authentication information transmitted via the broadcasting network, and then stored in the service using device.

A service providing device of the present invention for providing a service to a service using device, is arranged to include: an authentication information storage section for storing therein authentication information of a user authenticated for a service; an authentication section for performing authentication process for matching authentication information of a user requesting for a service, against the authentication information of the user authorized to receive the service, the authentication information being stored in the authentication being stored in the authentication information storage section; an enciphering section for enciphering the authentication information so as to create the enciphered authentication information; a deciphering section for deciphering the enciphered authentication information so as to create deciphered authentication information; and a providing device control section, wherein if the providing device control section receives first-time authentication information, the providing device control section causes the authentication section to perform the authentication process of the first-time authentication information, and if the authentication of the first-time authentication information is successful, the providing device control section causes the enciphering section to encipher the first-time authentication information so as to create enciphered authentication information and transmits back the thus created enciphered authentication information, and wherein if the providing device control section receives the enciphered authentication information, the providing device control section causes the deciphering section to decipher the thus received enciphered authentication information so as to create deciphered authentication information, and causes the authentication section to perform the authentication process of the thus created deciphered authentication information.

With the above arrangement, the service using device is only required to transmit the enciphered authentication information to the service providing device only at the first-time authentication. This alleviates work loads on the user to input the authentication information.

A second service providing device of the present invention for providing a service to a service using device, is arranged to include: an authentication information storage section for storing therein authentication information of a user authenticated for a service; an authentication section for performing authentication process for matching authentication information of a user requesting for a service, against the authentication information of the user authorized to receive the service; an authentication information input section for receiving an input of authentication information of a user who is authorized to receive the service; an enciphering section for enciphering the authentication information so as to create the enciphered authentication information; and a providing device control section for causing the enciphering section to encipher the authentication information of the user who is authorized to receive the service, so as to create enciphered authentication information, and transmits the thus created enciphered authentication information to the service using device.

With the above arrangement, the service using device can request for the service by using the enciphered authentication information received from the service providing device. Thus, the user does not need to input the authentication information. This alleviates work loads on the user to input the authentication information.

The service providing device may be arranged such that the providing device control section transmits the enciphered authentication information to the service using device via a broadcasting network. Moreover, the service providing device may be arranged such that the authentication information input section receives a terminal ID that identifies that service using device which is authorized to receive the service; and the providing device control section transmits the enciphered authentication information and the terminal ID to the service using device.

A service relaying device of the present invention for relaying between a service using device and a service providing device, which provides a service to the service using device, is arranged to include: an enciphering section for enciphering authentication information so as to create enciphered authentication information; a deciphering section for deciphering the enciphered authentication information so as to create deciphered authentication information; and a relaying control section, (a) wherein if the relaying control section receives first-time authentication information from the service using device, the relaying control section transmits the thus received first-time authentication information to the service providing device which provides the service, (b) wherein if the relaying control section receives the enciphered authentication information from the service using device, the providing device control section causes the deciphering section to decipher the thus received enciphered authentication information so as to create deciphered authentication information, and transmits the thus created deciphered authentication information to the service providing device, and (c) wherein in case where the first-time authentication information is transmitted to the service providing device, and if the relaying control section receives, from the service providing device, an authentication process result that informs success of the authentication process of the first-time authentication information, the relaying control section causes the enciphering section to encipher the first-time authentication information so as to create enciphered authentication information, and transmits the thus created enciphered authentication information back to the service using device that has transmitted the first-time authentication information.

With the above arrangement, the service using device is only required to transmit the enciphered authentication information to the service providing device only at the first-time authentication. This alleviates work loads on the user to input the authentication information.

A second service relaying device of the present invention for relaying between a service using device and a service providing device, which provides a service to the service using device, is arranged to include: an enciphering section for enciphering authentication information so as to create enciphered authentication information; and a relaying control-section that (a) causes the enciphering section to encipher authentication information of a user who is authorized to received the service, so as to create enciphered authentication information, the authentication information being received from the service providing device, and (b) transmits the thus created enciphered authentication information to the service using device.

With this arrangement, the service using device receives the enciphered authentication information from the service relaying device and stores the enciphered authentication information therein. The service can be requested by sending the enciphered authentication information to the service relaying device. This alleviates work loads on the user to input the authentication information.

A third service relaying device of the present invention for relaying between a service using device and a service providing device, which provides a service to the service using device, is arranged to include: an authentication information input section for receiving an input of authentication information and information that specifies that service providing device which performs authentication process by using that authentication information; an enciphering section for enciphering authentication information so as to create enciphered authentication information; and a relaying control section that (a) transmits the authentication information thus inputted via the authentication information input section to that service providing device which performs the authentication process by using that authentication information, and that (b) if the relaying control section receives, from that service providing device, an authentication process result that informs success of the authentication process, causes the enciphering section to encipher that authentication information for which the authentication is successful, so as to create enciphered authentication information, and then transmits the thus created enciphered authentication information to the service using device.

With this arrangement, the service using device receives the enciphered authentication information from the service relaying device and stores the enciphered authentication information therein. The service can be requested by sending the enciphered authentication information to the service relaying device. This alleviates work loads on the user to input the authentication information.

The service relaying device may be arranged such that the relaying control section transmits the enciphered authentication information to the service using device via a broadcasting network. In this case, the relaying control device may transmit, to the service using device, a terminal ID together with the enciphered authentication information, the terminal ID identifying that service using device which is authorized to receive the service.

An authentication method of the present invention for performing authentication for a user who request a service, in a service providing system comprising a service using device and a service providing device which provides a given service in accordance with a request from the service using device connected to the service providing device via the network, is arranged to include: the enciphering step for enciphering authentication information of a user who is authorized to receive the service, so as to recreate enciphered authentication information; the cipher storing step for causing the service using device to store therein the enciphered authentication information; the input step for causing the service using device to receive an instruction from the user, the instruction specifying a requested service; the service requesting step for transmitting, from the service using device to the service providing device, enciphered authentication information that corresponds to the requested service; the deciphering step for deciphering the thus transmitted enciphered authentication information so as to create deciphered authentication information; and the authentication step for matching the deciphered authentication information against the authentication information of the user who is authorized to receive the service.

According to this authentication method, the authentication information that corresponds to the requested service is not necessary to be inputted every time the user requests for the service, unlike the conventional art. This improves the authentication process to be user friendly. Moreover, in this arrangement, the enciphered authentication information is stored in the service using device. This provides better security (safety) to the authentication information.

An authentication method may include the judging step for judging whether or not the enciphered authentication information regarding the service specified by the instruction is stored in the service using device; the first-time authentication information input step for receiving an input of authentication information from the user, if the enciphered authentication information regarding the service specified by the instruction is not stored in the service using device; the first-time authentication step for matching (a) the authentication information thus received in the first-time authentication information input step, against (b) the authentication information of the user who is authorized to receive the service, and if, in the first-time authentication step, (a) the authentication information thus received in the first-time authentication information input step matches (b) the authentication information of the user who is authorized to receive the service, the enciphering step enciphering the authentication information so as to create enciphered authentication information, and the cipher storing step causing the service using device to store therein the thus created enciphered authentication information, then the enciphering step and the cipher storing step being performed.

Moreover, the enciphering step and the deciphering step may be carried out by a service relaying device that relays between the service using device and the service providing device.

According to this authentication method, the input operation of the authentication information becomes more user friendly, and the security of the authentication is improved. Moreover, a service providing device that is used in a conventional providing system may be employed in the this arrangement. Therefore, the existing service providing device can be utilized in the this arrangement.

A first authentication program according to the present invention is for causing a computer to execute the steps of the method. By causing a computer to read the first authentication program, it becomes possible to realize the processes of each steps in the method according to the present invention.

A second authentication program according to the present invention is for causing a computer provided to the service using device or a computer connected to the service using device to execute the first-time authentication information inputting step and the cipher storing step in the method. By causing a computer to read the second authentication program, it becomes possible to realize the processes of the first-time authentication information inputting step and the cipher storing step in the method according to the present invention. A third authentication program according to the present invention is for causing a computer provided to the service providing device or a computer connected to the service providing device to execute the enciphering step, the deciphering step, and the authentication step in the method. By causing a computer to read the third authentication program, it becomes possible to realize the processes of the enciphering step, the deciphering step, and the authentication step in the method according to the present invention.

A fourth authentication program according to the present invention is for causing a computer provided to the service relaying device or a computer connected to the service relaying device to execute the enciphering step and the deciphering step in the method in which the service relaying device is used. The service relaying device relays between the service providing device and service using device. By causing a computer to read the fourth authentication program, it becomes possible to realize the processes of the enciphering step and the deciphering step.

By recoding any one of the authentication programs in a computer-readable recording medium, storage and distribution of the program can be performed with ease. Further, by causing a computer to read the recording medium, it is possible to perform the process of the step(s) of the authentication method of the present invention by the computer.

The present invention is not limited to any of the embodiments described above and may be modified in any way within the scope of the following claims. Any embodiment that can be obtained by appropriately combining technical means disclosed in different ones of the embodiments is within the technical scope of the present invention.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A service providing system comprising a service using device, and service providing devices each of which provides a given service in accordance with a request from the service using device to which the service providing device is connected via a network, wherein:
the service using device comprises:
an input section for receiving an instruction from a user, the instruction specifying a requested service;
a cipher storage section for storing therein enciphered authentication information; and
a using device control section that transmits enciphered authentication information that corresponds to the requested service, to that service providing device which provides the requested service, and
each of the service providing devices comprises:
an authentication information storage section for storing therein authentication information of a user authenticated for a service;
an authentication section for performing authentication process for matching authentication information of the user requesting for the service, against the authentication information of the user authorized to receive the service;
a deciphering section for deciphering enciphered authentication information so as to create deciphered authentication information; and
a providing device control section wherein if the providing device control section receives the enciphered authentication information from the service using device, the providing device control section causes the deciphering section to decipher the thus received enciphered authentication information so as to create deciphered authentication information, and causes the authentication section to perform the authentication process of the thus created deciphered authentication information.

2. A service providing system as set forth in claim 1, wherein:
the using device control section judges whether or not enciphered authentication information corresponding to the requested service is stored in the cipher storage section, and if the enciphered authentication information corresponding to the requested service is not stored, the using device control section transmits, as first-time authentication information, authentication information to that service providing device which provides the requested service, the authentication information regarding the requested service and being provided from a user via the input section,
each of the service providing devices comprises:
an enciphering section for enciphering the authentication information so as to create the enciphered authentication information, and
if the providing device control section receives the first-time authentication information from the service using device, the providing device control section causes the authentication section to perform the authentication process of the first-time authentication information, and if the authentication of the first-time authentication information is successful, the providing device control section causes the enciphering section to encipher the first-time authentication information so as to create enciphered authentication information and transmits the thus created enciphered authentication information to the service using device that has transmitted the first-time authentication information thereto.

3. A service providing system as set forth in claim 1, wherein:
each of the service providing devices comprises:
an authentication information input section for receiving an input of authentication information of a user who is authorized to receive the service; and
an enciphering section for enciphering the authentication information so as to create the enciphered authentication information, and
the providing device control section causes the enciphering section to encipher the authentication information thus inputted into the authentication information input section so as to create the enciphered authentication information and transmits the thus created enciphered authentication information to the service using device.

4. A service providing system as set forth in claim 3, wherein:
the providing device control section transmits the enciphered authentication information to the service using device via a broadcasting network.

5. A service providing system as set forth in claim 4, wherein:
the authentication information input section receives a terminal ID that identifies that service using device which is authorized to receive the service,
the providing device control section transmits the enciphered authentication information and the terminal ID to the service using device.

6. A service providing system comprising a service using device, a service relay device, and service providing devices, the service relay device connecting, via a network, the service using device with that service providing device which provides a service that the service using device requests, and the service providing device or service providing devices being connected to the service relaying device via the network, wherein:
the service-using device comprises:
an input section for receiving an instruction from a user, the instruction specifying a requested service;
a cipher storage section for storing therein received enciphered authentication information; and
a using device control section that transmits the enciphered authentication information corresponding to the requested service, to the service relaying device,
each of the service providing devices comprises:
an authentication information storage section for storing therein authentication information of a user authenticated for a service;
an authentication section for performing authentication process for matching authentication information of the user requesting for the service, against the authentication information of the user authorized to receive the service; and
the service relaying device comprises:
a deciphering section for deciphering enciphered authentication information so as to create deciphered authentication information; and
a relaying control section, wherein if the relaying control section receives the enciphered authentication information from the service using device, the providing device control section causes the deciphering section to decipher the thus received enciphered authentication information so as to create deciphered authentication information, and transmits the thus created deciphered authentication information to that service providing device which provides a service that is requested by the service using device having transmitted the enciphered authentication information to the relaying control section.

7. A service providing system as set forth in claim 6, wherein:
the service providing device comprises a providing control section that transmits, to the service relaying device, authentication result information that informs a result of the authentication process;
the using device control section judges whether or not enciphered authentication information corresponding to the requested service is stored in the cipher storage section, and if the enciphered authentication information corresponding to the requested service is not stored, the using device control section transmits, as first-time authentication information, authentication information to the service relaying device, the authentication information regarding the requested service and being provided from a user via the input section;
the service relaying device comprises an enciphering section for enciphering the authentication information so as to create the enciphered authentication information;
if the relaying control section receives the first-time authentication information from the service using device, the relaying control section transmits the thus received first-time authentication information to that service providing device which provides a service that is requested by the service using device having transmitted the first-time authentication information to the relaying control section, and if the relaying control section receives, from the service providing device, an authentication process result that informs success of the authentication process of the first-time authentication information, the relaying control section causes the enciphering section to encipher the first-time authentication information so as to create enciphered authentication information, and transmits the thus created enciphered authentication information back to the service using device that has transmitted the first-time authentication information.

8. A service providing system as set forth in claim 7, wherein:
in case where the using device control section requests for plural services,
the using device control section transmits, to the service relaying device, a batch of respective pieces of the first time authentication information of the requested services,
the relaying control section (a) selects, from among the service providing devices connected to the relaying control section via the network, those service providing devices which provide services that correspond to the respective pieces of the first-time authentication information, and (b) transmits the respective pieces of the first-time authentication information thus received from the service using device, respectively to the thus selected service providing devices, and
if the relaying control section receives, from any one of the service providing devices, an authentication process result that informs success of the authentication process of the first-time authentication information, the relaying control section causes the enciphering section to encipher the first-time authentication information so as to create enciphered authentication information, and transmits the thus created enciphered authentication information back to the service using device that has transmitted the first-time authentication information.

9. A service providing system as set forth in claim 7, wherein:
in case where the using device control section requests for plural services,
the using device control section (a) judges whether or not respective pieces of enciphered authentication information of the requested services are stored in the ciphering storage section, (b) receives, from the user, input of authentication information of that service which is not stored in the cipher storage section, and (c) transmits the thus received authentication information to the service relay device as first-time authentication information,
the relaying control section (d) selects, from among the service providing devices connected the service relay device via the network, those service providing devices which provide services that correspond to the respective pieces of the first-time authentication information, and (e) transmits the respective pieces of the first-time authentication information thus received from the service using device, respectively to the thus selected service providing devices, and
if the relaying control section receives an authentication process result from any one of the service providing devices, the relaying control section causes, the enciphering section to encipher the first-time authentication information so as to create enciphered authentication information, and transmits the thus created enciphered authentication information back to the service using device that has transmitted the first-time authentication information.

10. A service providing system as set forth in claim 7, wherein:
each of the service providing devices comprises an authentication information input section for receiving an input of authentication information of a user who is authorized to receive the service;
the providing device control section transmits, to the service relaying device, the authentication information thus inputted via the authentication information input section;
the relaying control section comprises an enciphering section for enciphering authentication information so as to create enciphered authentication information; and
if the relaying control section receives the authentication information from the service providing device, the relaying control section causes the enciphering section to encipher the authentication information so as to create enciphered authentication information, and transmits the thus created enciphered authentication information to the service using device.

11. A service providing system as set forth in claim 7, wherein:
the service relaying device comprises:
an authentication information input section for receiving an input of authentication information and information that specifies that service providing device which performs authentication process by using that authentication information; and
an enciphering section for enciphering authentication information so as to create enciphered authentication information, and
the relaying control section transmits the authentication information thus inputted via the authentication information input section to that service providing device which performs the authentication process by using that authentication information, and if the relaying control section receives, from that service providing device, an authentication process result that informs success of the authentication process, the relaying control section causes the enciphering section to encipher that authentication information for which the authentication is successful, so as to create enciphered authentication information, and then transmits the thus created enciphered authentication information to the service using device.

12. A service providing system as set forth in claim 10, wherein:
the relaying control section transmits the enciphered authentication information to the service using device via a broadcasting network.

13. A service providing system as set forth in claim 12, wherein:
the relaying control device transmits, to the service using device, a terminal ID together with the enciphered authentication information, the terminal ID identifying that service using device which is authorized to receive the service.

14. A service providing system as set forth in claim 11, wherein:
the relaying control section transmits the enciphered authentication information to the service using device via a broadcasting network.

15. A service providing system as set forth in claim 14, wherein:
the relaying control device transmits, to the service using device, a terminal ID together with the enciphered authentication information, the terminal ID identifying that service using device which is authorized to receive the service.

16. A service providing system as set forth in claim 7, wherein:
in case where the using device control section requests for plural services,
the using device control section (a) judges whether or not respective pieces of enciphered authentication information of the requested services are stored in the ciphering storage section, (b) if all the pieces of enciphered authentication information of the requested service are stored, transmits all the pieces of enciphered authentication information to the service relay device,
the relaying control section (c) causes the deciphering section to decipher the respective pieces of enciphered authentication information thus received from the service using device, so as to create respective pieces of deciphered authentication information, (d) selects, from among the service providing devices connected the service relay device via the network, those service providing devices which provide services that correspond to the respective pieces of the deciphered authentication information, and (e) transmits the respective pieces of deciphered authentication information, respectively to the thus selected service providing devices, and
the relaying control section receives service contents respectively from the service providing devices and transmits back to a batch of the thus received service contents to the service using device.

17. A service using device for receiving a service from a service providing device, comprising:
an input section for receiving an instruction from a user, the instruction specifying a requested service;
a cipher storage section for storing therein thus received enciphered authentication information; and
a using device control section that transmits enciphered authentication information that corresponds to the requested service, to that service providing device which provides the requested service.

18. A service using device as set forth in claim 17, wherein:
the using device control section judges whether or not enciphered authentication information corresponding to the requested service is stored in the cipher storage section, and if the enciphered authentication information corresponding to the requested service is not stored, the using device control section transmits, as first-time authentication information, authentication information to that service providing device which provides the requested service, the authentication information regarding the requested service and being provided from a user via the input section.

19. A service using device as set forth in claim 17, comprising:
a receiving section for receiving enciphered authentication information and a terminal ID transmitted via a broadcasting network; and
a terminal ID judging section for judging whether or not the thus received terminal ID is an own terminal ID of the service using device, and
if the thus received terminal ID is the own terminal ID of the service using device, the using device control section causing the cipher storage section to store therein the thus received enciphered authentication information together with the terminal ID.

20. A service using device as set forth in claim 17, communicating with the service providing device via a service relaying device.

21. A service providing device for providing a service to a service using device, comprising:
an authentication information storage section for storing therein authentication information of a user authenticated for a service;
an authentication section for performing authentication process for matching authentication information of a user requesting for a service, against the authentication information of the user authorized to receive the service;
an enciphering section for enciphering the authentication information so as to create the enciphered authentication information;
a deciphering section for deciphering the enciphered authentication information so as to create deciphered authentication information; and
a providing device control section, wherein if the providing device control section receives first-time authentication information, the providing device control section causes the authentication section to perform the authentication process of the first-time authentication information, and if the authentication of the authentication process is successful, the providing device control section causes the enciphering section to encipher the first-time authentication information so as to create enciphered authentication information and transmits back the thus created enciphered authentication information, and wherein if the providing device control section receives the enciphered authentication information, the providing device control section causes the deciphering section to decipher the thus received enciphered authentication information so as to create deciphered authentication information, and causes the authentication section to perform the authentication process of the thus created deciphered authentication information.

22. A service providing device for providing a service to a service using device, comprising:
an authentication information storage section for storing therein authentication information of a user authenticated for a service;
an authentication section for performing authentication process for matching authentication information of a user requesting for a service, against the authentication information of the user authorized to receive the service;
an authentication information input section for receiving an input of authentication information of a user who is authorized to receive the service; an enciphering section for enciphering the authentication information so as to create the enciphered authentication information; and
a providing device control section for causing the enciphering section to encipher the authentication information of the user who is authorized to receive the service, so as to create enciphered authentication information, and transmits the thus created enciphered authentication information to the service using device.

23. A service providing device as set forth in claim 22, wherein:
the providing device control section transmits the enciphered authentication information to the service using device via a broadcasting network.

24. A service providing device as set forth in claim 23, wherein:
the authentication information input section receives a terminal ID that identifies that service using device which is authorized to receive the service; and
the providing device control section transmits the enciphered authentication information and the terminal ID to the service using device.

25. A service relaying device for relaying between a service using device and a service providing device, which provides a service to the service using device, comprising:
an enciphering section for enciphering authentication information so as to create enciphered authentication information;
a deciphering section for deciphering the enciphered authentication information so as to create deciphered authentication information; and
a relaying control section, (a) wherein if the relaying control section receives first-time authentication information from the service providing section, the relaying control section transmits the thus received first-time authentication information to the service providing device which provides the service, (b) wherein if the relaying control section receives the enciphered authentication information from the service using device, the providing device control section causes the deciphering section to decipher the thus received enciphered authentication information so as to create deciphered authentication information, and transmits the thus created deciphered authentication information to the service providing device, and (c) wherein in case where the first-time authentication information is transmitted to the service providing device, and if the relaying control section receives, from the service providing device, an authentication process result that informs success of the authentication process of the first-time authentication information, the relaying control section causes the enciphering section to encipher the first-time authentication information so as to create enciphered authentication information, and transmits the thus created enciphered authentication information back to the service using device that has transmitted the first-time authentication information.

26. A service relaying device for relaying between a service using device and a service providing device, which provides a service to the service using device, comprising:
an enciphering section for enciphering authentication information so as to create enciphered authentication information; and
a relaying control section that (a) causes the enciphering section to encipher authentication information of a user who is authorized to received the service, so as to create enciphered authentication information, the authentication information being received from the service providing device, and (b) transmits the thus created enciphered authentication information to the service using device.

27. A service relaying device for relaying between a service using device and a service providing device, which provides a service to the service using device, comprising:
an authentication information input section for receiving an input of authentication information and information that specifies that service providing device which performs authentication process by using that authentication information;
an enciphering section for enciphering authentication information so as to create enciphered authentication information; and
a relaying control section that (a) transmits the authentication information thus inputted via the authentication information input section to that service providing device which performs the authentication process by using that authentication information, and that (b) if the relaying control section receives, from that service providing device, an authentication process result that informs success of the authentication process, causes the enciphering section to encipher that authentication information for which the authentication is successful, so as to create enciphered authentication information, and then transmits the thus created enciphered authentication information to the service using device.

28. A service relaying device as set forth in claim 26, wherein:
the relaying control section transmits the enciphered authentication information to the service using device via a broadcasting network.

29. A service relaying device as set forth in claim 28, wherein:
the relaying control device transmits, to the service using device, a terminal ID together with the enciphered authentication information, the terminal ID identifying that service using device which is authorized to receive the service.

30. A service relaying device as set forth in claim 27, wherein:
the relaying control section transmits the enciphered authentication information to the service using device via a broadcasting network.

31. A service relaying system as set forth in claim 30, wherein:
the relaying control device transmits, to the service using device, a terminal ID together with the enciphered authentication information, the terminal ID identifying that service using device which is authorized to receive the service.

32. An authentication method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

33. An authentication method as set forth in claim 32, comprising:
the judging step for judging whether or not the enciphered authentication information regarding the service specified by the instruction is stored in the service using device;
the first-time authentication information input step for receiving an input of authentication information from the user, if the enciphered authentication information regarding the service specified by the instruction is not stored in the service using device;
the first-time authentication step for matching (a) the authentication information thus received in the first-time authentication information input step, against (b) the authentication information of the user who is authorized to receive the service,
if, in the first-time authentication step, (a) the authentication information thus received in the first-time authentication information input step matches (b) the authentication information of the user who is authorized to receive the service, the enciphering step enciphering the authentication information so as to create enciphered authentication information, and the cipher storing step causing the service using device to store therein the thus created enciphered authentication information, then the enciphering step and the cipher storing step being performed.

34. An authentication method as set forth in claim 32, wherein:
the enciphering step and the deciphering step are carried out by a service relaying device that relays between the service using device and the service providing device.

35. An authentication program for causing a computer to execute a whole or part of the steps of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

36. An authentication program for causing (a) a computer provided to the service using device, or (b) a computer connected to the service using device, to execute the cipher storing step, input step, service requesting step of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

37. An authentication program for causing (a) a computer provided to a service providing device, or (b) a computer connected to the service providing device, to execute the enciphering step, deciphering step, authentication step of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

38. An authentication program for causing (a) a computer provided to a service relaying device relaying between the service using device and the service providing device, or (b) a computer connected to the service relaying device, to execute the enciphering step and deciphering step of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

39. A computer-readable recording medium storing therein an authentication program for causing a computer to execute a whole or part of the steps of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

40. A computer-readable recording medium storing therein an authentication program for causing (a) a computer provided to the service using device, or (b) a computer connected to the service using device, to execute the cipher storing step, input step, service requesting step of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

41. A computer-readable recording medium storing therein an authentication program for causing (a) a computer provided to a service providing device, or (b) a computer connected to the service providing device, to execute the enciphering step, deciphering step, authentication step of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

42. A computer-readable recording medium storing therein an authentication program for causing (a) a computer provided to a service relaying device relaying between the service using device and the service providing device, or (b) a computer connected to the service relaying device, to execute the enciphering step and deciphering step of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

43. A series of data signals representing an authentication program for causing a computer to execute a whole or part of the steps of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

44. A series of data signals representing an authentication program for causing (a) a computer provided to the service using device, or (b) a computer connected to the service using device, to execute the cipher storing step, input step, service requesting step of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

45. A series of data signals representing an authentication program for causing (a) a computer provided to a service providing device, or (b) a computer connected to the service providing device, to execute the enciphering step, deciphering step, authentication step of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.

46. A series of data signals representing an authentication program for causing (a) a computer provided to a service relaying device relaying between the service using device and the service providing device, or (b) a computer connected to the service relaying device, to execute the enciphering step and deciphering step of a method for performing authentication for a user who request a service, in a service providing system comprising a service using device and a service providing device which provides a given service in accordance with a request from the service using device connected to the service providing device via the network, the method comprising:
the enciphering step for enciphering authentication information of a user who is authorized to receive the service, so as to recreate enciphered authentication information;
the cipher storing step for causing the service using device to store therein the enciphered authentication information;
the input step for causing the service using device to receive an instruction from the user, the instruction specifying a requested service;
the service requesting step for transmitting, from the service using device to the service providing device, enciphered authentication information that corresponds to the requested service;
the deciphering step for deciphering the thus transmitted enciphered authentication information so as to create deciphered authentication information; and
the authentication step for matching the deciphered authentication information against the authentication information of the user who is authorized to receive the service.
